(19) United States
(12) Patent Application Publication
(10) Pub. No.: US 2012/0122715 A1
(43) Pub. Date: May 17, 2012

(54) ELECTRICAL SENSOR FOR ULTRASENSITIVE NUCLEIC ACID DETECTION

(76) Inventors: Zhiqiang Gao, Singapore (SG); Somenath Roy, Singapore (SG); Xiaojun Chen, Singapore (SG)

(21) Appl. No.: 13/255,901

(22) PCT Filed: Mar. 11, 2010
(86) PCT No.: PCT/SG2010/000086

§ 371 Date: Jan. 20, 2012

(30) Foreign Application Priority Data
Mar. 11, 2009 (SG) 200901668-4

(51) Int. Cl. C40B 30/04; G01N 27/00; B05D 5/12; C40B 40/06

(52) U.S. Cl. 506/9; 422/69; 506/16; 436/501; 427/58

(57) ABSTRACT

The present invention is direct to a sensor for detecting a nucleic acid molecule comprising an electrode arrangement with two electrodes and nucleic acid probes immobilized at the surface of the electrodes. The present invention also refers to a kit and a method of using the sensor or a sensor array. The present invention is further directed to a process of manufacturing a sensor and sensor array.

### CROSS-REFERENCE TO RELATED APPLICATIONS

This application claims the benefit of priority of Singapore patent application No. 200901668-4, filed Mar. 11, 2009, the contents of it being hereby incorporated by reference in its entirety for all purposes.

### FIELD OF THE INVENTION

The present invention refers to the field of electrochemistry. In more detail, the present invention refers to the detection of a nucleic acid using electrochemical devices and methods.

### BACKGROUND OF THE INVENTION

With the advent of nucleic acid, e.g. DNA and RNA, microarrays, the last decade witnessed a paradigm shift in gene expression profiling and single nucleotide polymorphism (SNP) detection. Microarray technology, for example in conjunction with polymerase chain reactions (PCR), has become the state-of-the-art owing to its massive parallelism and high throughput. In spite of exhibiting considerable promises to the development of molecular biology and medicine, the fluorescence-based microarray technique suffers from some inherent shortcomings in optical detections, including the need for expensive and bulky optical scanners, potential image corruption from photo-bleaching of fluorescence dyes and ambiguous readout due to spectral cross-talk between tagging fluorescence dyes. Electronic analogues of the nucleic acid microarray could offer a viable alternative for the rapid quantification of nucleic acid, which is especially desirable for clinical and defense applications.

In the past few years, researchers have proposed several labeled and label-free sensing technologies that feature direct electronic transduction. The direct electrical transduction has several advantages with respect to other approaches. One of the most promising is the feasibility for on-chip integration of sensor units with an allied signal processing circuitry, using standard CMOS technology. Referring to the literature, field-effect devices have been investigated more widely, using various micro- and nano-fabrication techniques, than resistive or capacitive devices. In the former class of devices electronic properties are modulated by changes in surface potential upon the introduction of charged molecules (e.g. nucleic acids) via bioaffinitive interaction on gate dielectric. Field-effect sensing avoids the conduction of current through the DNA, which may produce unwanted electrochemical changes. Nevertheless, the most critical parameters that limit the applications of field-effect sensors for DNA detections are—(i) a nominal signal-to-background ratio and (ii) a narrow window of detection. In addition, the reliability of the signal is often questionable because the d.c readout electronics suffer from the usual long-term drift at the gate input.

More recently, Shiigi, H., Tokonami, S., et al. (2005, J. Am. Chem. Soc., vol. 127, pp. 3280) constructed a film of gold nanoparticles (GNP), with decanedithiol as a spacer, between platinum microelectrodes. In their approach, the authors monitored the tunneling of charge carriers before and after the formation of the receptor-target molecule complex, bridging the adjacent GNPs. Since the flow of charge carriers through a DNA molecule is rather limited, the change in the baseline electrical current upon hybridization was less than 1%, making this approach prone to yield false signals. In another effort, Roy, S., Vedala, H., et al. (2008, Nano Lett., vol. 8, pp. 26) exploited a single-stranded DNA (ss-DNA) sandwiched between a pair of carbon nanotube electrodes to probe into its native charge conductivity of the ss-DNA as well as its hybridized duplex. Due to the presence of very short chemical linkers between the carbon nanotube electrodes and the capture probes, the signal-to-noise ratio was enhanced to 25%. Although interesting for fundamental understanding of the charge flow mechanism, the reliability of signal from such a single nanotube-single DNA system may not be high enough to be accepted in the biomedical community.

Furthermore, the ability to affordably and efficiently fabricate highly uniformed nanostructures with high scale-up potentials is important to many technical applications, and yet it remains a technical challenge. Most of the bottom-up approaches suffer from certain limitations such as device-to-device uniformity, reflecting the variations in the device fabrication processes, low yield, and low scalability. On the other hand, the widely used top-down approaches for fabricating narrow nanogaps, such as mechanical break junction, electron beam lithography, electromigration, dip-pen lithography, transmission electron microscope-assisted nanosputtering, and electroplating have to resolve issues such as high cost and low yield, in order to be one step closer to routine fabrications.

It is therefore an object of the present invention to provide novel devices and methods which are suitable to overcome at least some of the above disadvantages.

### SUMMARY OF THE INVENTION

In a first aspect, the present invention is directed to a sensor for detecting a nucleic acid molecule. This sensor comprises or consists of:

an electrode arrangement comprising a first electrode, a second electrode and an overlapping region, wherein, within the overlapping region:
a part of the second electrode overlaps a part of the first electrode such that a top surface level of the second electrode is higher than a top surface level of the first electrode;
an insulating layer is provided between the first electrode and the second electrode and is contacting the first electrode and second electrode;

a first nucleic acid probe immobilized at the surface of the first electrode; and

a second nucleic acid probe immobilized at the surface of the second electrode.

In another aspect, the present invention is directed to a nucleic acid detection kit. The kit comprises or consists of:

a sensor as described herein;

a solution comprising a metal precursor; and

a solution suitable for chemically reducing the metal precursor.

In a further aspect, the present invention is directed to a process of manufacturing a sensor of the present invention. This process comprises or consists of:
providing an electrode arrangement as described herein;
immobilizing a first nucleic acid probe at the surface of a first electrode and a second electrode;
stripping of the first nucleic acid probe from the surface of the first electrode or the second electrode by potential cycling of either the first electrode or the second electrode; and
immobilizing a second nucleic acid probe at the surface of the electrode from which the first nucleic acid probe has not been stripped of.

In still a further aspect, the present invention is directed to a method of detecting a target nucleic acid. This method comprises or consists of:
providing a sensor according to any one of claims 1 to 29 wherein the sensor comprises two electrodes and wherein nucleic acid sequences are immobilized at the surface of the electrodes which are complementary to the target nucleic acid sequence;
incubating the sensor in a first step with a sample fluid suspected to comprise the target nucleic acid;
metallizing the nucleic acid molecules of the sensor; and
carrying out a conductance measurement to determine the presence or absence of the target nucleic acid.

### BRIEF DESCRIPTION OF THE DRAWINGS

The invention will be better understood with reference to the detailed description when considered in conjunction with the non-limiting examples and the accompanying drawings, in which:

FIG. 1 FIG. 1B shows a stepped electrode arrangement in which the top electrode (1) partly overlaps the bottom electrode (2) thereby forming a stepped arrangement. The upper step of the stepped arrangement is formed by the top surface of the top electrode (1) which overlaps the bottom electrode (2) in the overlapping region 4 (striped area). The lower step of the stepped arrangement is formed by the top surface of the bottom electrode (2). In the embodiment illustrated in FIG. 1(B), the edge between the steps is formed by three side walls (1′, 1″, 1′″) comprising part of the top electrode (1) and the insulation layer (3) arranged in between. In FIG. 2(G) the side wall of the step is illustrated under reference number 200. FIG. 1(A) shows a stepped electrode arrangement in which the top electrode overlaps the bottom electrode entirely. The edge of the stepped electrode arrangement is formed by two side walls (1′, 1″) of the top electrode and the insulating layer arranged between the bottom and top electrode. FIG. 1(C) shows a stepped electrode arrangement as it can be used in sensor arrays. The top electrode runs over the bottom electrode thus forming a step in the section in which the top and bottom electrode overlap. As in FIG. 1(A), the edge of the stepped electrode arrangement shown in FIG. 1(C) is formed by two side walls of the top electrode and the insulating layer arranged between the bottom and top electrode. FIGS. 1D to 1F show electrode arrangements in which a first nucleic acid probe and a second nucleic acid probe are immobilized at the surface of the first and second electrode, respectively. For illustrative purposes only one nucleic acid probe is shown to be immobilized at the electrode surfaces but in fact multiple nucleic acid probes are immobilized at the electrode surfaces. The nucleic acid probes can be immobilized directly to the electrode surface or via a linker (round end located between nucleic acid probe and electrode surface in FIGS. 1D to F.

FIG. 2 and FIG. 3 illustrate a process for manufacturing a sensor according to an embodiment of the present invention. The top layer 110 of a silicium wafer substrate 120 is oxidized (SiO₂ layer 110). In a first step (FIG. 3 A) the top layer 110 of the substrate layer 120 is coated with a photoresist layer 100. In FIGS. 3 B and 2 (step 1) it is shown how this photoresist layer is patterned and developed in a second step to define the space for the first electrode. In a third step (FIG. 3 C) the material forming the first electrode is deposited 130. It is also possible to first deposit an adhesive layer followed by the material forming the first electrode. In a fourth step (FIG. 3D) the photoresist layer 100 and any electrode material 130 covering the photoresist layer is removed to form the first electrode 130 (FIG. 2, step 2). In a fifth step the insulating layer 140 is deposited over the previously formed layers to cover the first electrode 130 as well as the substrate layer 110 (FIG. 3 E and step 3 in FIG. 2). In further steps the space for the second electrode is patterned by applying another photoresist layer 160 (step 4 in FIG. 2). After depositing of the material forming the second electrode 150 and any optional adhesive layer, the photoresist layer 160 is removed which results in the arrangement illustrated in step 5 of FIG. 2 (see also FIG. 3 F). In a last step the insulating layer 140 is removed except the portions covered by the material forming the second electrode 150 leaving behind the electrode arrangement illustrated in FIG. 2, step 6 and FIG. 3 G. This method results in a stepped electrode arrangement with the side wall of the step 200 formed between the top surface of the first electrode 130 and the top surface of the second electrode 150. The side 200 is formed by the second electrode 150 and the insulating layer 110.

FIG. 4 illustrates the results of an ellipsometric study of a deposited silicon oxide film 110 over an entire silicon wafer 120.

FIG. 5 shows AFM images of a silicon oxide substrate layer and a gold electrode layer. (RMS roughness of gold layer <1.5 nm). This image shows the first electrode which is comprised of an adhesive layer made of Cr which is in direct contact with the substrate SiO₂ layer and the gold layer of the first electrode.

FIG. 6 shows an optical image of 5×5 array of stepped microsensors fabricated on a 1.2×1.2 cm² silicon chip. The diameter of the one Euro cent coin is 16.25 mm.

FIG. 7 shows an atomic force microscopy (AFM) image of the insulator (SiO₂)/bottom electrode (Au) interface.

FIG. 8 (A) shows a schematic illustration of a sensor device. A 5-20 nm thick insulating layer 140 is sandwiched between a pair of Au microelectrodes 130, 150. The width of the insulating layer 140 (“nanogap”) can easily be modulated by changing the insulating layer thickness. (B) Sensing procedure: (I) two different nucleic acid capture probes (wavy lines in FIG. 8 (B)) immobilization across the step formed between the top 150 and bottom electrode 130; (II) hybridization with target DNA (wavy line bound between top and bottom nucleic acid probe); (III) formation of silver wires along the backbone of the bridging molecule that results in formation of an electrical conducting pathway(s) between the electrode pair.

FIG. 9 shows a stereomicroscopic image of a typical sensor array chip (dimension: 10 mm×10 mm).

FIG. 10 shows immobilization of two different capture probes on the two electrodes separated by an insulating layer: (A) optical image of a cleaned sensor (both electrode lanes, i.e. horizontal lane=bottom electrode and vertical lane=top electrode, show same color); (B) fluorescence image of the device after immobilization of CP1 and hybridization with its complementary target DNA tagged with Cy3 dye (top and bottom electrode are red colored); (C) electrochemical stripping of CP1 from the bottom electrode followed by hybridization with the Cy3-labeled DNA (only top electrode appears in red; bottom electrode does not show any color); (D) fluorescence image after immobilization of CP2 and hybridization with respective complementary DNAs' tagged with Cy3 and FAM dyes (top electrode appears in red; bottom electrode appears in green).

FIG. 11 (A, top) shows representative i-V curve for 1.0 fM target DNA as referred to background (control) and (B, middle) calibration curves, and (C, bottom) i-V curves of mismatch discrimination tests at 1.0 μM. For clarity, the i-V curve of the single-base mismatched target is scaled up 10 times. The error bars represent the variation of data for each set of five measurements.

FIG. 12 i-V curves of PKB2 gene at various concentrations ranging from 1.0 fM to 100 pM.

FIG. 13 shows SEM images: (A) silicon oxide after silver treatment; (B) a blank sensor chip at the step junction, i.e. the step between top electrode and bottom electrode; (C) a capture probe coated control sensor chip; (D) a 1.0 pM PKB2 hybridized sensor chip after silver treatment.

FIG. 14 shows the schematic illustration of sensing mechanism for RNA detection.

FIG. 15 shows representative i-V curve for 100 ng total RNA as referred to background (control).

FIG. 16 illustrates electrical responses of (1) 10 ng total RNA and (2-4) strand RNA spikes in 5.0 fM increment.

FIG. 17 shows calibration curve for conductance vs. GAPDH concentration. The error bars represent the variation of data for each set of five measurements.

### DETAILED DESCRIPTION OF THE PRESENT INVENTION

In a first aspect the present invention refers to a sensor for detecting a nucleic acid molecule. This sensor comprises or consists of an electrode arrangement comprising a first electrode, a second electrode and an overlapping region, wherein, within the overlapping region a part of the second electrode overlaps a part of the first electrode such that a top surface level of the second electrode is higher than a top surface level of the first electrode thus forming a stepped structure; an insulating layer is provided between the first electrode and the second electrode and is contacting the first electrode and second electrode. The sensor further comprises a first nucleic acid probe immobilized at the surface of the first electrode; and a second nucleic acid probe immobilized at the surface of the second electrode.

The design of this sensor takes into account the feasibility of mass production in a cost-effective way by using standard silicon microfabrication technologies. The sensing mechanism relies on bridging the edge formed between the top surface of the first electrode and the top surface of the second electrode upon hybridization of the two termini of a target nucleic acid, such as DNA or RNA with two different surface-bound capture probes, followed by a simple metallization step. For example, about two orders of magnitude enhancement in conductance, as referred to a clean background (<1.0 pS), are obtained in the presence of as little as 1.0 fM target DNA. Also, in one embodiment, a linear relationship between the conductance and nucleic acid concentration was obtained from 1.0 fM to 1.0 μM with an exceptional signal intensity of 2.1×10⁴% change per unit concentration. This change in conductivity is so large that it can unambiguously detect the concentration of nucleic acid quantitatively and may obviate the need for target amplification used for example in current DNA tests. Moreover, in use, this sensor exhibits excellent single-base mismatch discrimination due to its unique vertically aligned nanostructure and the two-probe configuration.

With respect to RNA detection, distinct conductance change was observed in the presence of as little as 0.30 fM of mRNA. For example, in one embodiment, a linear relationship between the conductance and mRNA concentration was obtained from 0.50 fM to 10 pM with an exceptional signal intensity of more 2 orders of magnitude change per unit concentration. This change in conductance was so large that it could unambiguously and quantitatively determine the expression levels of mRNAs and may, as for DNA, obviate the need for target amplification used in current mRNA expression analysis tests. For example, as low as 50% difference in gene expression can be successfully differentiated in as little as 10 ng total RNA.

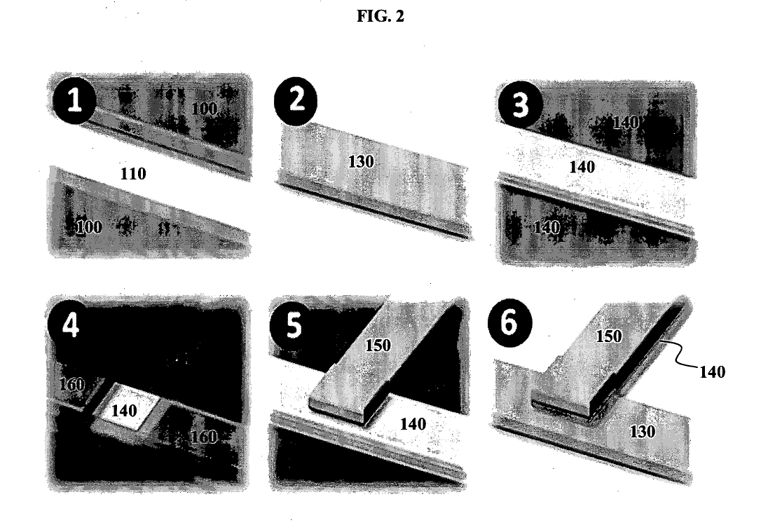

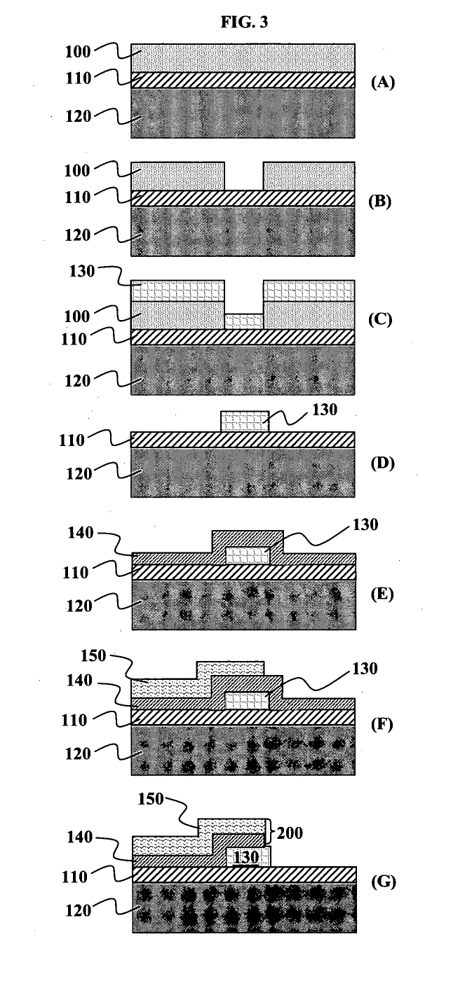

The stepped arrangement of the electrodes in the sensor of the present invention can be varied to create steps between the electrodes with a height of the edge formed between the top surface of the second electrode (see e.g. 150 in FIG. 2) in the overlapping region and the top surface of the first electrode (see e.g. 130 in FIG. 2) of between about 50 nm to about 535 nm. As illustrated for example in FIG. 3 (G), the thickness of the edge of the step between the electrodes 200 is determined by the thickness of the second electrode 150 and the thickness of the insulation layer 140.

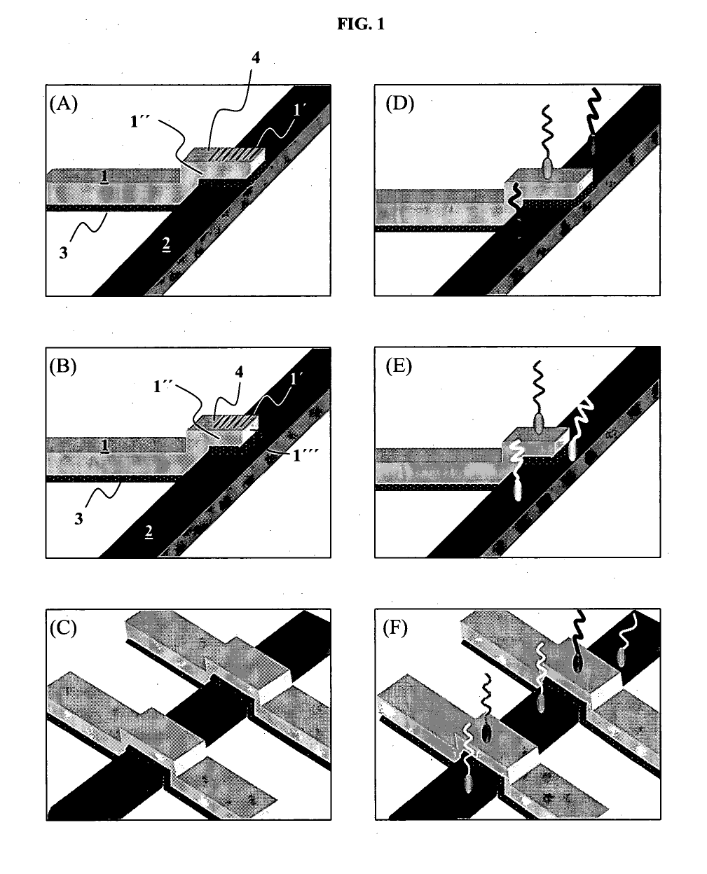

In one embodiment the side surface(s) of the second electrode and the insulating layer (see e.g. 1′, 1″, and 1′″ in FIG. 1(B)) is aligned with respect to the top surface of the second electrode by an angle of between about 80° to 90° or in one embodiment by an angle of 90°±30° or an angle of 90°±20°. This way a sharp edge is formed between the second electrode and the first electrode in the overlapping region. This allows for example immobilizing nucleic acids in close proximity to the bottom of the edge and thus providing excellent conditions for a bridge formation even of shorter target nucleic acids which bind to the nucleic acid probes immobilized at the top surface of the second electrode and the top surface of the bottom electrode in close proximity to the step. The stepped sensor arrangement allows detecting target nucleic acids with a length of at least 40 nucleotides. The length of the target nucleic acid which can be detected depends largely also on the distance between the top surfaces of the second and first electrode separated from each other in the overlapping region by the insulating layer. As higher the step as longer the target nucleic acid needs to be to bridge the gap and bind to the nucleic acid probes immobilized at the top surfaces of the electrodes (see e.g. FIG. 8(B)). It is also noted that a nucleic acid probe immobilized at the second electrode can be immobilized at the part of the side wall (see e.g. 1′, 1″ or 1′″ in FIGS. 1A and B) formed by the second electrode. Thus, the effective minimum separation between the second and first electrode that a bridging target nucleic acid molecule would encounter is the thickness of the insulating layer or in case an adhesion layer is comprised the thickness of insulating layer and adhesion layer.

The second electrode can overlap the first electrode entirely as it is the case in a sensor array (see FIG. 1C) or in case of a single sensor configuration as illustrated in FIG. 1(A). With overlapping the first electrode entirely it is meant that the overlapping region of the second electrode overlaps the entire width of the first electrode but not also the entire length of the first electrode. In a sensor array the second electrode can extend over multiple first electrodes as shown in FIG. 1(C) and FIG. 6. It is also possible that the overlapping region of the second electrode overlaps the first electrode only to a certain percentage as shown for example in FIG. 1(B) and FIG. 3 (G). The overlapping region of the second electrode can overlap at least about 5% of the first electrode or between about 10% to about 95% of the first electrode, about 97% of the first electrode, about 99% of the first electrode, or about 50% of the first electrode. In case the overlapping region of the second electrode overlaps the first electrode only to a certain percentage as illustrated for example in FIG. 1 (B), a further edge (1′″) is formed which increases the possible sites for binding of nucleic acid probes and thus the possible sensitivity of the sensor.

The thickness of the first electrode and the second electrode can be the same or different. In one embodiment, the thickness of the first electrode and the second electrode can be independently from each other between about 50 nm to about 500 nm. In one embodiment, the thickness of each of the electrodes can be independently from each other between about 50 nm to about 300 nm, or between about 50 nm to about 200 nm. In one example, the electrodes have a thickness of 75 nm or 100 nm or 150 nm or 200 nm or 250 nm. The width of each of the electrodes can be the same or different from each other. The width of the first and second electrode can be independently selected from a range of between about 0.1 μm and about 100 μm.

The insulating layer (3 in FIG. 1) separating the first and second electrode has a compact and homogeneous structure. The insulating layer can have a thickness of between about 1 nm and about 50 nm, or between 1 nm and 20 nm, or between 5 nm and 15 nm. It is also possible that the thickness of the insulating layer varies depending on the material used for it. For example, in one embodiment the insulating layer can have a thickness of 20 nm or between about 10 nm and 20 nm in case SiO₂ is used as material for the insulating layer. In another example, the insulating layer can have a thickness of about 2 nm or between about 1 nm to about 5 nm in case a material with a relative dielectric constant (κ) of at least 10 is used. The unique design and morphology of the sensor of the present invention results in a leakage current of the insulating layer which is below 1 pS at a bias of 1 V, in some cases only between about 0.2 to about 0.8 pS.

The insulating layer is a very homogeneous layer which means that the insulating layer has a surface roughness of below 0.5 nm. A surface roughness above 0.5 nm the leakage current will increase between the first and second electrode which can be detrimental to the performance of the device and negatively influences sensitivity of the sensor arrangement.

In another embodiment an adhesion layer can be arranged between the insulating layer and the first electrode, or between the insulating layer and the second electrode, or between the insulating layer and the electrode of both, first and second electrode. Due to lattice mismatch and difference in thermal expansion coefficient between different materials, two layers of different materials do not always adhere to each other. Hence an adhesion layer is required which acts as a buffer between two active material layers. Sometimes there is atomic (molecular) diffusion at the interface or alloy (compound) formation which make the respective interface more stable. Without an adhesion layer, a thin film electrode layer, such as a thin film electrode layer of Au or Pt might peel off from a substrate coated with an insulating layer, such as an SiO₂-coated Si or glass substrate. The adhesion layer can have a thickness in a range of between about 2 nm and about 30 nm or between about 5 nm and 25 nm, or between about 2 nm and 15 nm. In one embodiment the thickness of the adhesion layer is between about 2 nm and about 5 nm.

The electrode arrangement referred to herein can be arranged on a substrate. The substrate can have a thickness of between about 20 nm and about 200 nm. In one embodiment the substrate has a thickness of between about 20 nm±0.7 nm and about 200 nm±0.7 nm. This substrate can be arranged on a further substrate layer, such as a layer made of a semiconducting material. The semiconducting material can be for example silicium, germanium, gallium arsenide, or silicon carbide. Other materials include mixtures of arsenic, selenium and tellurium. In one embodiment the semiconducting material is silicium. For example, FIG. 3 (G) illustrates an embodiment in which a substrate layer 110 is deposited on a further substrate layer 120. The first electrode 130 and the insulting layer 140 are arranged on the substrate layer 110.

The substrate layer 110 can be made of the same or a different material as the insulating layer 140. For example, in one embodiment the substrate layer 110 is made of a metal oxide, such as SiO₂. However, other substrate materials than SiO₂ can be used as well. For example, an insulating material that can withstand at least 300° C. (temperature at which insulating layer is deposited thereafter, e.g. by PECVD) without any degassing, deformation or melting can be used. In one embodiment, the material used as substrate layer should also be able to withstand organic solvents. One such example is silicon nitride (Si₃N₄).

In some embodiment, a further substrate layer, such as the further substrate layer 120 is used. The purpose of having an insulating substrate layer 110 is to prevent electrical crosstalk between the neighboring metal electrodes on the same plane. That means that in case another material than a semiconducting material, such as Si, is used as further substrate material 120, such as glass, quartz or any such insulating substrate (like ceramics) no substrate layer 110 will be required. Thus, the substrate layer 110 or 120 can include, but is not limited to a semiconducting material, such as Si, glass, quartz, Si₃N₄ or ceramics.

The insulating layer can be made of a material with a high relative dielectric constant (κ) or SiO₂. Other terms for the relative dielectric constant (κ) are the dielectric constant, or relative static permittivity, or static dielectric constant. Relative dielectric constant is the ratio of a material's electrical permittivity to the electrical permittivity in a vacuum (that is defined as one). The relative dielectric constant (κ) is a measure of the ability of a material to store a charge from an applied electromagnetic field and then transmit that energy. In one embodiment, the insulating layer can be made of a material with a relative dielectric constant (κ) of at least 10. Examples for materials with a relative dielectric constant (κ) of at least 10 include, but are not limited to Ta₂O₅, Al₂O₃, ZrO₂, and HfO₂.

If present, the adhesion layer is made of a metal. Examples for suitable metals include, but are not limited to Cr, Zr, Si, Al+TiN, IrO₂ or Ti. For example, mostly for an Au electrode material Ti or Cr are used as material for the adhesion layer. Commonly, for noble metal electrodes, Si, Al, Al plus TiN, or IrO₂ can be used as material for the adhesion layer. For example, for Pt electrodes, Ti or Zr can be used as material for the adhesion layer. The first and second electrode can be made of the same or different materials. The electrodes are made of material including, but not limited to a noble metal, doped silicon, doped poly silicon, silicon germanium, titanium (Ti), tantalum (Ta), tungsten (W), aluminum (Al), chromium (Cr), copper (Cu), a metal alloy or a conducting polymer. Noble metals which can be used herein include gold, platinum, iridium, palladium, osmium, silver, rhodium, and ruthenium. Examples of metal alloys include, but are not limited to titanium-nitirde (TiN), tantalum-nitride (TaN), Mg₂Ni, CaNi₅, CO₃Sn₂, NdFeB, and metal silicide.

The nucleic acid probe immobilized at the surface of the first electrode can be the same nucleic acid probe like the nucleic acid probe immobilized at the surface of the second electrode or differ from the nucleic acid probe immobilized at the surface of the second electrode.

In its general meaning, the term “nucleic acid” as used herein refers to any nucleic acid in any possible configuration, such as single stranded, double stranded or a combination thereof. Nucleic acids include for instance DNA molecules, RNA molecules, analogues of the DNA or RNA generated using nucleotide analogues or using nucleic acid chemistry, locked nucleic acid molecules (LNA), PNA molecules and tecto-RNA molecules (e.g. Liu, B., et al., J. Am. Chem. Soc. (2004) 126, 4076-4077). An LNA molecule has a modified RNA backbone with a methylene bridge between C4′ and O2′, which locks the furanose ring in a N-type configuration, providing the respective molecule with a higher duplex stability and nuclease resistance. Unlike a PNA molecule an LNA molecule has a charged backbone. DNA or RNA may be of genomic or synthetic origin and may be single or double stranded. Such nucleic acid can be e.g. mRNA, cRNA, synthetic RNA, genomic DNA, cDNA synthetic DNA, a copolymer of DNA and RNA, oligonucleotides, micro RNA having a length of between about 21 to 23 nucleotides etc. A respective nucleic acid may furthermore contain non-natural nucleotide analogues.

Many nucleotide analogues are known and can be present and/or used herein. A nucleotide analogue is a nucleotide containing a modification at for instance the base, sugar, or phosphate moieties. As an illustrative example, a substitution of 2′-OH residues of siRNA with 2′F, 2′O-Me or 2′H residues is known to improve the in vivo stability of the respective RNA. Modifications at the base moiety include natural and synthetic modifications of A, C, G, and T/U, different purine or pyrimidine bases, such as uracil-5-yl, hypoxanthin-9-yl, and 2-aminoadenin-9-yl, as well as non-purine or non-pyrimidine nucleotide bases. Other nucleotide analogues serve as universal bases. Universal bases include 3-nitropyrrole and 5-nitroindole. Universal bases are able to form a base pair with any other base. Base modifications often can be combined with for example a sugar modification, such as for instance 2′-O-methoxyethyl, e.g. to achieve unique properties such as increased duplex stability.

The nucleic acid probe immobilized at the surface of the first and second electrode is a single stranded nucleic acid which is complementary to the target nucleic acid which it is intended to bind. Binding of the target nucleic acid takes place through Watson-crick base pairing and the formation of a double-stranded nucleic acid. The nucleic acid of the nucleic acid probe can be any nucleic acid referred to herein. In one embodiment the nucleic acid probe is made of DNA or RNA. Both DNA and RNA are composed of repeating units of nucleotides. Each nucleotide consists of a sugar, a phosphate and a nucleic acid base. The sugar in DNA is deoxyribose. The sugar in RNA is ribose, the same as deoxyribose but with one more OH (oxygen-hydrogen atom combination called a hydroxyl). A major difference between DNA and RNA is that DNA contains the nucleic acid base thymine, but not uracil, while RNA contains uracil but not thymine. The other three heterocyclic amines, adenine, guanine, and cytosine are found in both DNA and RNA.

The nucleic acid probes used herein can have a length of between about 5 to about 50 nucleotides or between about 10 to 50 nucleotides, or between about 15 to 30 nucleotides. In one embodiment the nucleic acid probes have a length of at least 10 or 40 or 60 nucleotides. The length of the first and second nucleic acid probe can be the same or different.

The nucleic acid probe is immobilized at the surface of the first and second electrode by methods known in the art. Nucleic acids are generally immobilized at the surface of the electrodes via a linker molecule. Thiol-groups are often used for immobilization of nucleic acids at the surface of metals.

For example, in one embodiment short oligonucleotides were anchored onto gold surfaces by preparing terminally thiolated oligonucleotides using solid phase DNA synthesizing techniques (described e.g. in Kelley, S. O., Barton, J. K., et al., 1998, Langmuir, vol. 14, pp. 6781). Hanna et al. used 5-[(4-azidophenacyl)thio]-UTP, 5-APAS-UTP and 5-APAS-CTP to crosslink RNA to metal surfaces. These modified nucleotides contain azido groups, which are used to activate such cross-linking and can be introduced into RNA molecules by an in vitro transcription reaction (Hanna, M. M., Dissinger, S., et al., 1989, Biochemistry, vol. 28, pp. 5814; Hanna, M. M., Zhang, Y., et al., 1993, Nucleic Acids Res., vol. 21, pp. 2073). WO 03038108 discloses a method of modifying purine or pyrimidine bases of already existing nucleic acid strands to introduce thiol groups for immobilization to a metal surface. The density of nucleic acid probes at the surface of an electrode can be in a range of between about 1×10⁻¹²-5×10⁻¹¹ mol/cm².

In another aspect, the present invention is directed to a method of detecting a target nucleic acid. This method comprises or consists of the following steps: providing a sensor described herein, wherein the sensor comprises two electrodes and wherein nucleic acid sequences are immobilized at the surface of the electrodes which are complementary to the target nucleic acid sequence; incubating the sensor with a sample fluid suspected to comprise the target nucleic acid; metallizing the nucleic acid molecules of the sensor; carrying out a conductance measurement to determine the presence or absence of the target nucleic acid.

In such a method the salt, such as NaCl etc., concentration can be in the range of between about 0.01 to 1.0 mM. In one embodiment the temperature can be in the range of between about 10° C. to about 90° C. The pH can be in a range of between about 3 to 9. Thus, the above method can be carried out over a broad range of different conditions with the sensor described herein. A pre-treatment of the sample suspected to comprise the target nucleic acid sequence is also not necessary for carrying out the above method for detecting a target nucleic acid sequence.

At first the sensor (see e.g. FIG. 8 (B) I) is contacted with a solution which is suspected to comprise the target nucleic acid. In case the target nucleic acid is comprises in the solution, the target nucleic acid with undergo complementary binding with the nucleic acid probes immobilized at the surfaces of the first and second electrode (see e.g. FIG. 8 (B) II).

After contacting the sensor with the solution which for example comprises the target nucleic acid to be detected, the method can further include several wash steps. The washing steps are supposed to clean off any substances which can obstruct the later following electrical measurements and/or the deposition of metals at the bound target nucleic acid strands. It is also possible to subject the sensor after hybridization of the target nucleic acid to stringent washes to remove any nonspecifically adsorbed or partially hybridized nucleic acid strands from the sensor. For stringent washes solution with different salt concentrations are used. For example, the less concentrated the salt solution and the longer the duration of the stringent wash and the temperature, the higher the stringency and the more nucleic acid will be removed. This wash can be done at temperatures between 25° C. and 75° C., in two to three steps of about 2 to 5 minutes each. Such methods are known in the art and a person skilled in the art will know how to adapt the stringent washes for the respective target nucleic acid detection.

After hybridization of the target nucleic acid to the nucleic acid probes and after the optional wash steps, the hybridized nucleic acid is undergoing a metallization step. Methods for metalizing nucleic acids are known in the art (see e.g. Braun, E., Eichen, Y., et al., 1998, Nature, vol. 391, pp. 775). Metallization includes the deposition on electrically conduction metal ions, such as noble metal ions (see noble metals referred to above), on the nucleic acid complex formed between target nucleic and the nucleic acid probes immobilized at the surface of the electrodes. After deposition the metalized nucleic acid strands forms a nanowire (see FIG. 8 (B) III) which conducts an electrical current much more efficiently than the nucleic acid as such.

Thus, to increase electrical functionality of the nucleic acid, electrically conduction metal ions are vectorially deposited along the nucleic acid molecule. The chemical deposition process is based on selective localization of metal ions, such as silver ions along the nucleic acid through, e.g. Ag⁺/Na⁺ ion-exchange and formation of complexes between the silver and the nucleic acid bases. In the embodiment using silver ions, the silver ion-exchanged nucleic acid is then reduced to form nanometre-sized metallic silver aggregates bound to the nucleic acid skeleton. These noble metal aggregates are subsequently further ‘developed’, much as in the standard photographic procedure, using a chemically reducing solution and nobel metal ions under low light conditions. The chemically reducing solution can be an acidic solution such as a solution comprising hydroquinone.

Thus, in one embodiment the metallization step comprises the step of contacting the sensor with a solution comprising a metal precursor; and afterwards contacting the sensor with a solution comprising a reducing agent suitable for chemically reducing the noble metal precursor.

Examples of suitable metal precursors, such as noble metal precursors include, but are not limited to AgNO₃, [Ag(NH₃)₂]⁺ (aq), HAuCl₄.3H₂O, H₂PtCl₆.6H₂O, PdCl₂, K₂PdCl₄, RuCl₃, H₂PdCl₆.6H₂O or mixtures thereof in case the nucleic acid is to be metalized with a mixture of different metal ions.

A reducing agent suitable for chemically reducing the noble metal precursor can include, but is not limited to hydroquinone, ascorbic acid (AA), boranes, such as dimethylsulfide borane, decaborane, catecholborane or borane-tetrahydrofuran complex; copper hydride, citric acid, diisobutylaluminium hydride (DIBAL-H), diethyl 1,4-dihydro-2,6-dimethyl-3,5-pyridinedicarboxylate, ethanol, ethyleneglycol (EG), formaldehyde, formic acid, hydrazine, hydrogene, lithium aluminum hydride (LiAlH₄), 3-mercaptopropionic acid (3-MPA), methanol, nickel borohydride, silane, such as phenylsilane, tris(trimethylsilyl)silane (TTMSS), trichloro silane, triethylsilane (TES), polymethylhydrosiloxane (PMHS) or polymethylhydrosiloxane; isopropanol (2-propanol), sodium bis(2-methoxyethoxy)aluminumhydride (Red-Al), sodium hydroxymethanesulfinate (Rongalite), sodium borohydride (NaBH₄), sodium cyanoborohydride, sodium dithionite (Na₂S₂O₄), sodium triacetoxyborohydride, tetramethyldisiloxane (TMDSO, TMDS), tributyltin hydride (tributylstannane), triphenylphosphine or triphenylphosphite. In one embodiment, hydroquinone in NH₃ solution is used.

In a further aspect, the present invention refers to a nucleic acid detection kit. The kit can comprise or consist of a sensor as described herein, a solution comprising a metal precursor of a metal which is electrically conducting, such as a noble metal; and a solution suitable for chemically reducing the metal precursor.

Such a nucleic acid detection kit can be used for example, for characterizing nucleic acid of pathogens, measuring mRNA levels during expression profiling or in point-of-care applications, such as for detecting infectious diseases, for cancer diagnosis and treatment, to name only a few. The possible to arrange the sensor in a sensor array further allows the parallel detection of multiple target nucleic acids. The sensor or sensor array referred to herein can also be integrated in a readout unit for detecting a range of target nucleic acids. With the sensor and this kit it is possible to detect full-length genes. The sensor is sensitive enough that it also allows differentiation of single-base mismatches in nucleic acid sequences as described in the experimental section of this application.

In another aspect, the present invention is directed to a process of manufacturing a sensor of the present invention. This process comprises providing an electrode arrangement as described herein. Afterwards a first nucleic acid probe is immobilized at the surface of the first electrode and the second electrode. In case two different nucleic acid probes are to be immobilized on the two electrodes, the first nucleic acid probe immobilized at the surface of the first and second electrode is stripped of by potential cycling of either the first electrode or the second electrode. Afterwards the second nucleic acid probe which is different from the first nucleic acid probe is immobilized at the surface of the electrode from which the first nucleic acid probe has not been stripped of.

The electrode arrangement of this process is manufactured using standard lithographic methods such as reactive ion etching (RIE) and photolithography-liftoff processes. The RIE process resulted in a better definition of the sidewall of the stepped electrode arrangement.

Thus in one embodiment, the process of manufacturing the sensor comprises formation of a first electrode on a substrate. Afterwards, an insulating layer which covers the substrate and the first electrode is formed. Then the second electrode covering a portion of the substrate covered with the insulating layer is formed. The second electrode is formed to overlap a portion of the first electrode covered with the insulating layer thus forming an overlapping region. The portion of the insulating layer which is not covered by the second electrode is removed, thus forming the stepped electrode arrangement as shown for example in FIG. 1.

An example of manufacturing an electrode arrangement in which the overlapping region overlaps only part of the first electrode is described with reference to FIGS. 2 and 3. FIG. 3(A) shows that a silicium wafer of about 500 μm thickness is provided as a substrate layer 120. The top layer 110 of the silicium wafer substrate 120 is oxidized. The top layer 110 is coated with photoresist using spin-coating. As shown in FIGS. 2(1) and 3(A), a photoresist layer 100 which is about 0.5 μm to about 2 μm thick is formed. FIG. 3(B) shows that the photoresist layer 100 is patterned by exposure to UV lamp via a mask and developed to form a cavity. FIGS. 2 (2) 3(C) shows that a highly pure gold layer (50 nm to 300 nm) 130 is deposited above a chromium (Cr) layer (not shown) which is deposited above the remaining portions of the photoresist layer 100 and in the cavity. FIG. 3(D) shows that the photoresist layer 100 is removed together with the portions of the gold layer 130 deposited above it by subjecting it to acetone. The first electrode 130 is formed. FIG. 2 (3) and FIG. 3 (E) shows that an insulating layer 140 is deposited (5 nm to 200 nm) by plasma-enhanced chemical vapor deposition (PECVD) or by sputtering above the top layer 110 and the first electrode 130.

FIG. 2 (4) shows that a photoresist layer 160 (not shown) is deposited above the insulating layer 140 and is patterned to form a cavity for deposition of the second electrode 150. FIGS. 2 (5) and 3 (F) show that the second electrode 150 is deposited and the photoresist layer 160 is removed to result in the patterned second electrode 150. FIGS. 2 (6) and 3 (G) show that portions of the insulating layer 140, which are not covered by the second electrode 150, are removed by reactive ion etching (RIE). A side wall 200 of the stepped electrode arrangement is formed. The side wall 200 forms part of the overlapping region which covers in the specific example shown in FIG. 3 almost 90% of the first electrode.

As already mentioned, the insulating layer can be manufactured using sputtering or plasma-enhanced chemical vapor deposition (PECVD). PECVD uses electrical energy to generate a glow discharge (plasma) in which the energy is transferred into a gas mixture (precursor gas). This transforms the gas mixture into reactive radicals, ions, neutral atoms and molecules, and other highly excited species. These atomic and molecular fragments interact with a substrate located in a chamber and, depending on the nature of these interactions, either etching or deposition processes occur at the substrate. Since the formation of the reactive and energetic species in the gas phase occurs by collision in the gas phase, the substrate can be maintained at a low temperature. Thin layers formed by PECVD are characterized good adhesion, low pinhole density, good step coverage, and uniformity.

In one embodiment, tetraethoxysilane (TEOS) is used as source for silicon in the PECVD method for the manufacture of the insulating layer. Oxygen can be used as precursor gas in the PECVD method. The time for the deposition of the insulating layer using the PEVCD method can be between about 40 seconds and 2 minutes. In one example, the time is about 45 seconds.

For the manufacture of the insulating layer, the pressure of the gas in the chamber of the PECVD reactor is about 800 mTorr (106.66 Pa) to 1000 mTorr (133.32 Pa). In one embodiment the pressure is about 850 mTorr (113.32 Pa).

In one embodiment, the flow rate of the precursor gas oxygen into the chamber of the PEVCD reactor is between about 0.03 m³/s sccm and about 0.04 m³/s or about 0.033 m³/s for the manufacture of the insulating layer. On the other hand the flow rate of TEOS into the chamber can be between about 0.4 l/min to about 0.6 l/min. In one example, the flow rate of TEOS was about 0.5 l/min.

As described herein, in case the first and electrode are to be coated with different nucleic acid probes, the first nucleic acid probe needs to be removed from the top surface of one of the two electrodes before the second nucleic acid probe can be immobilized thereon. Specifically removing a nucleic acid probe from the surface of an electrode is possible through electric stripping. In this process the electrode from which surface the nucleic acid probe is to be removed is subjected to a potential cycling against a reference electrode. The potential cycling is carried out in a range of between about 0.1 to 1 V. In one embodiment, the scan rate for this potential cycling is about 150 to 250 mV/s. In one example, the scan rate is about 200 mV/s.

The inventions illustratively described herein may suitably be practiced in the absence of any element or elements, limitation or limitations, not specifically disclosed herein. Thus, for example, the terms “comprising”, “including”, “containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the inventions embodied therein herein disclosed may be resorted to by those skilled in the art, and that such modifications and variations are considered to be within the scope of this invention.

The invention has been described broadly and generically herein. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein.

Other embodiments are within the following claims and non-limiting examples. In addition, where features or aspects of the invention are described in terms of Markush groups, those skilled in the art will recognize that the invention is also thereby described in terms of any individual member or subgroup of members of the Markush group.

### Experimental Section

Chemicals and Materials

Thiol-terminated DNA capture probes used herein were custom-made by Sigma-Genosys (Woodlands, Tex.) and used as received. Other oligonucleotides were from 1^{st} Base Pte Ltd (Singapore). All other reagents were purchased from Sigma-Aldrich (St. Louis, Mo.) and used without further purification. Phosphate-buffered saline (PBS, 10 mM phosphate buffer+139 mM NaCl+2.7 mM KCl) was used in CP (capture probe) and AP (annealing probe) immobilization. A pH 8.5 10 mM Tris-HCl-1.0 mM EDTA-0.10 M NaCl (TE) buffer solution was used as the first hybridization and washing buffer and TE buffer containing 50 mM MgCl₂ (TEM) buffer was used in the second hybridization and washing. Messenger RNA standards (cDNA) RT-PCR products of the corresponding mRNAs. Total RNA was extracted using TRIzol reagent (Invitrogen, Carlsbad, Calif.) according to the manufacturer's recommended protocol. The yield and quality of total RNA were routinely assessed by gel electrophoresis and UV spectrometric measurements. To minimize the effect of RNases on the stability of miRNAs, diethyl pyrocarbonate treated dionized water was used for all sample solutions and buffers preparation and surfaces were decontaminated with RNaseZap (Ambion, Tex.). To remove any organic residue or remnant photoresist, the devices were first cleaned in Nanostrip® solution for 15 min, thoroughly rinsed with DI-water and dried in a stream of nitrogen.

Fabrication of Sensors

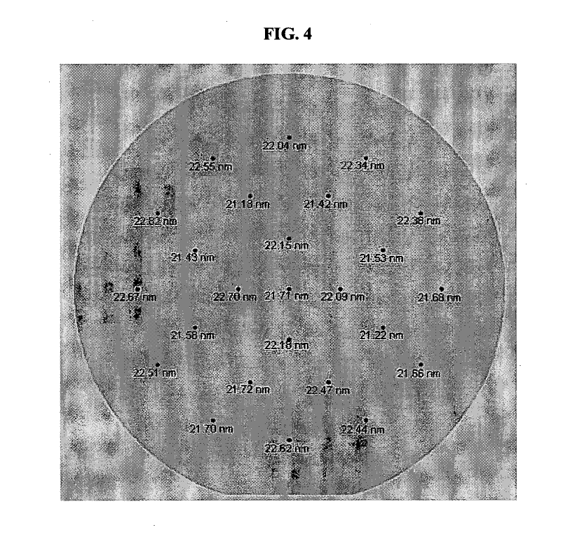

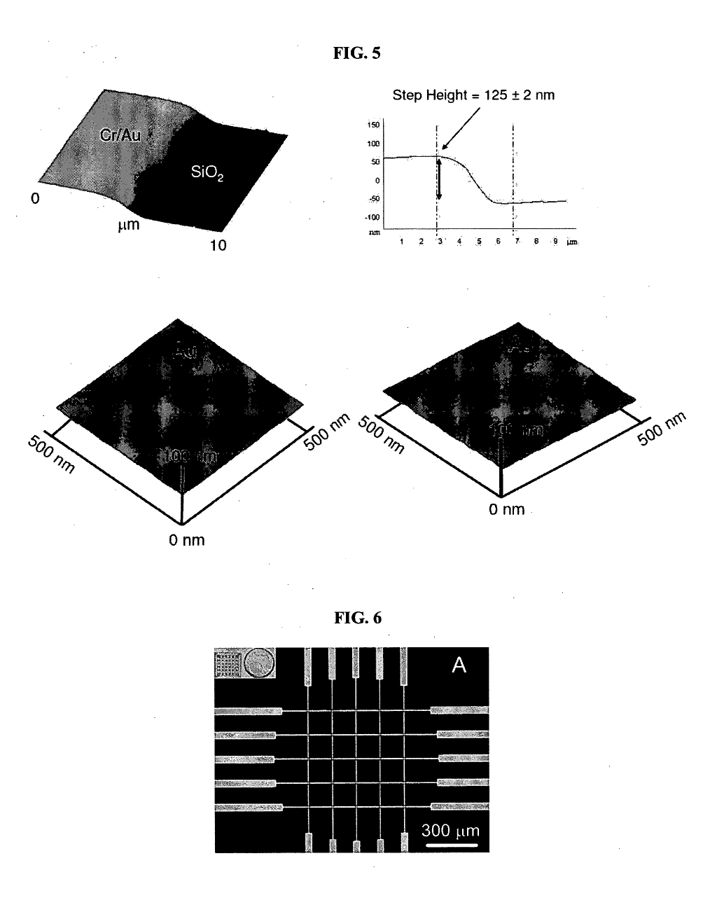

Metal/insulator/metal multilayer (hereinafter abbreviated as “nano-MIM”) devices were fabricated on 4 in. silicon wafers (coated with 500 nm SiO₂) using standard photolithography techniques (FIG. 2). Well-defined sidewalls of the insulating layer and the top electrode, necessary for molecular bridging, were patterned by two different methods: (i) reactive ion etching (RIE) and (ii) photolithography-liftoff processes. The RIE process resulted in a much better definition of the sidewalls (see e.g. FIG. 3). Therefore, it was employed in the fabrication process. Plasma enhanced chemical vapor deposition (PECVD) was used to deposit a SiO₂ insulating layer. After realizing the bottom electrode, a 5-20 nm SiO₂ insulating layer was deposited on the entire wafer by the PECVD method using tetraethoxyorthosilicate (TEOS) vapor as a source for silicon and O₂ as precursor gas. The morphology and electrical properties of the SiO₂ insulating layer play a pivotal role in the performance of the nano-MIM sensors. Therefore, a very compact and homogeneous SiO₂ layer had to be manufactured. A 45 s deposition time with O₂ and TEOS vapor flow rates of 2000 sccm and 0.5 L/min, respectively, at a chamber pressure of 850 mTorr was used. By ellipsometric measurements, it was determined that, under the above conditions, there was only <0.5 nm variation in the SiO₂ layer thickness over the entire 4 in. substrate (FIG. 4). A standard photolithography process was then performed to pattern the top electrode followed by a RF magnetron sputtering of Au (150 nm) on a Ti (15 nm) adhesion layer. After lift-off, the wafer was placed in a RIE chamber for selective and complete removal of the SiO₂ layer from the undesired portion of the bottom electrode. In this case, the top metal layer stack acted as a well-defined mask for etching the SiO₂ layer, and microscopic observation suggested that reasonably sharp edges and smooth gold surfaces were obtained (FIG. 5). Good nano-MIM structures with the SiO₂ insulating layer as thin as 5 nm can easily be fabricated through adjusting experimental variables in the SiO₂ deposition process.

Sensor Array Fabrication

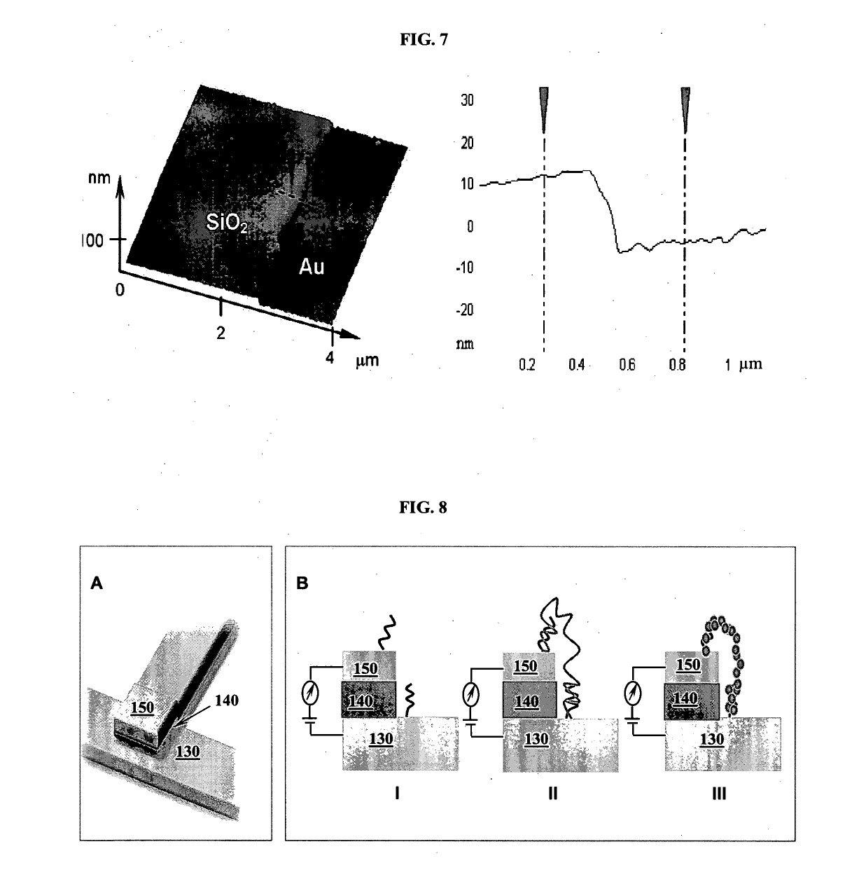

The sensor array, consisted of up to 1600 individual nanogap sensors with a vertically aligned gold/SiO₂/gold sandwich structure, was fabricated on a 1.5×1.5 cm silicon chip with 500 nm coating of SiO₂ by using standard photolithographic techniques. An optical image of an array chip, consisting of total 625 individual nanogap sensors [(5×5)×(5×5)] was shown in FIG. 6. As already mentioned above, the roughness of the bottom gold electrode played a pivotal role in the performance of the nanogap sensor. The characeristics, such as surface roughness of the gold electrode were determined by performing AFM characterizations of the gold electrode surface. In this embodiment, the roughness of the gold layer was well within 2 nm. Plasma enhanced chemical vapor deposition (PECVD) was then used to deposit the SiO₂ insulating layer, using tetraethoxyorthosilicate (TEOS) vapor as a source for silicon and O₂ as precursor gas under optimized conditions. Ellipsometric measurements showed that the variation in SiO₂ thickness was less than 0.50 nm over the entire wafer. Well-defined sidewalls of the insulating layer and the top gold electrode, necessary for mRNA bridging, were produced by reactive ion etching (RIE) as described above using the top gold layer as a natural mask. Electron microscopic observations suggested that sharp edges and smooth gold surfaces were obtained (see FIG. 7).

Capture Probe (CP) Immobilization

In this exemplary embodiment two sets of capture probes with different sequences were used. The 5′ forward capture probe (CP1; SEQ ID NO: 1) was a 21-base oligonucleotide with a spacer length of 9 bases, while the 3′ reverse capture probe (CP2; SEQ ID NO: 2) was also a 21-base oligonucleotide. With these probes, a full-length human protein kinase B-2 (PKB2, 1446 bp; SEQ ID NO: 4) could be detected as the model target DNA. The characteristics of both capture probes are unique for PKB2, and the probes hybridize to the 5′ and 3′ ends of PKB2, respectively. In brief, a freshly cleaned sensor was incubated in phosphate-buffered saline (PBS:10 mM phosphate buffer, 139 mM NaCl, and 2.7 mM KCl) containing 1.0 μm CP1 solution for 2 h at room temperature, rinsed with copious amount of DI water, and dried in a stream of nitrogen. At this stage, one could expect self-assembled monolayers (SAM) of CP1 on both electrodes (top and bottom) through thiol-gold interaction. Subsequently, the device was subjected to electrochemical stripping that would selectively and completely remove CP1 from the bottom electrode. A single potential cycling of the bottom electrode was performed between 0 and 1.0 V (vs Ag/AgCl) at a scan rate of 200 mV/s. Next, the device was incubated in a solution containing 1.0 μm CP2 for 2 h at room temperature. It was ready after a thorough wash with DI water.

Hybridization and Detection

After immobilization of CP1 and CP2 on the two electrodes, respectively, the nanogap was bridged by a 30 min hybridization with aliquots of 5.0 μL of the target DNA of various concentrations in TE buffer (10 mM Tris-HCl at pH 8.0, 100 mM NaCl, and 1.0 mM EDTA) where the two termini were complementary to the two surface-bound capture probes, respectively. After hybridization, the device underwent three stringency washes with SSC buffer (80 mM NaCl, 8 mM sodium citrate, and 0.1% sodium dodecyl sulfate; 5-7° C. below melting temperature) to remove any nonspecifically adsorbed or partially hybridized DNA strands. Finally, the hybridized molecules across the gap were made electrically conducting by a simple metallization step. The process consists of the vectorial “collection” of silver ions along the hybridized DNA strands followed by hydroquinonecatalyzed reductive formation of silver nanowires along the DNA skeletons (Braun, E., Eichen, Y., 1998, Nature, vol. 391, pp. 775). Briefly, the hybridized sensor was incubated in 0.10 M AgNO₃ in ammonia (pH=10.5) for 10 min. After a thorough rinsing, the adsorbed silver ions were reduced by 50 mM hydroquinone in ammonia (pH=10.5). The conductance measurements were performed with a parameter analyzer. To better visualize the formation of silver nanowires, a silver enhancement process was applied to the samples for scanning electron microscopic (SEM) experiments. That is, after the silver ion collection and reduction on the sensor, 1.0 mM AgNO₃ in citrate buffer (pH=3.5) and 2.0 mM hydroquinone in citrate buffer (pH=3.5) were mixed and applied onto the sensor. Usually 5-10 min was sufficient to form highly visible silver nanowires under SEM.

Results

Sensor Fabrication

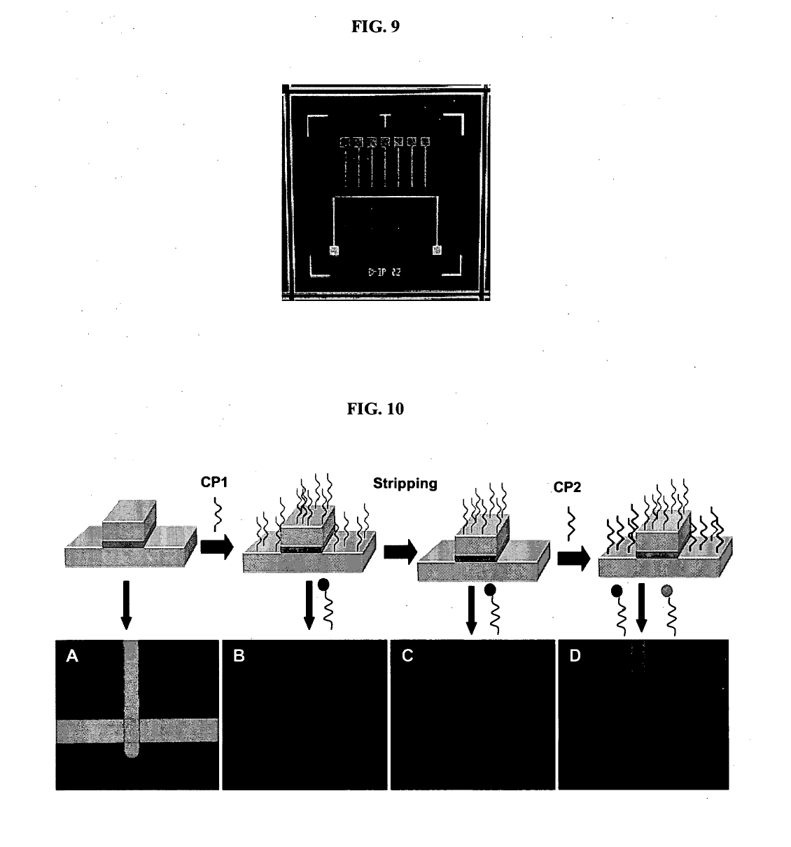

Illustrations of the nanogap device along with the sensing procedure are depicted in FIG. 8. The nano-MIM was fabricated, where a nanometer-thick layer of insulator, such as SiO₂ was sandwiched between a pair of vertically stacked metal layers (conductors). The SiO₂ insulating layer forms a “step” or “nanogap” between the top and the bottom metal electrodes on which two capture probes with different sequences, complementary to the two termini of the target DNA, respectively, were immobilized. Bridging of this nanogap by the target DNA strand, upon hybridization and subsequent silver nanowire formation, creates a primary current pathway (FIG. 8 (B)). Non-complementary DNA strands, that fail to hybridize with the capture probes, do not bridge across the step formed between the top and bottom electrode and thus will not contribute to the current between the two metal electrodes. Vital to the feasibility of this approach is to have a nominal background current, which should preferably be several orders of magnitude lower than the signal generated after DNA or RNA bridging. In general, the background current is primarily due to tunneling of charge carriers through the insulating layer in the relatively large common area of the electrodes (5 μm×5 μm). For demonstration purpose, an array of seven devices was fabricated on a 100 mm² substrate area (FIG. 9), although a higher scale of integration is possible following the same fabrication procedure.

By using this process, it was possible to fabricate the sensor arrays of different gap sizes that varies from 5 to 100 nm with precise control of insulating layer size ((1.0 nm) with high device uniformity and unlimited scalability. As it is known, the morphology and electrical properties of the insulating layer are critical for desired performances of the sensor. For example, for a 10-20 nm thick SiO₂ layer, surface roughness was found to be about 0.5 nm (FIG. 7). The leakage current (the conductance of the blank sensor chip) was found to be in the range of about 0.2 to about 0.8 pS, also at an applied bias of 1 V. This extremely low leakage current prompted subsequent applications of this device in nucleic acid detection.

Capture Probes Immobilization

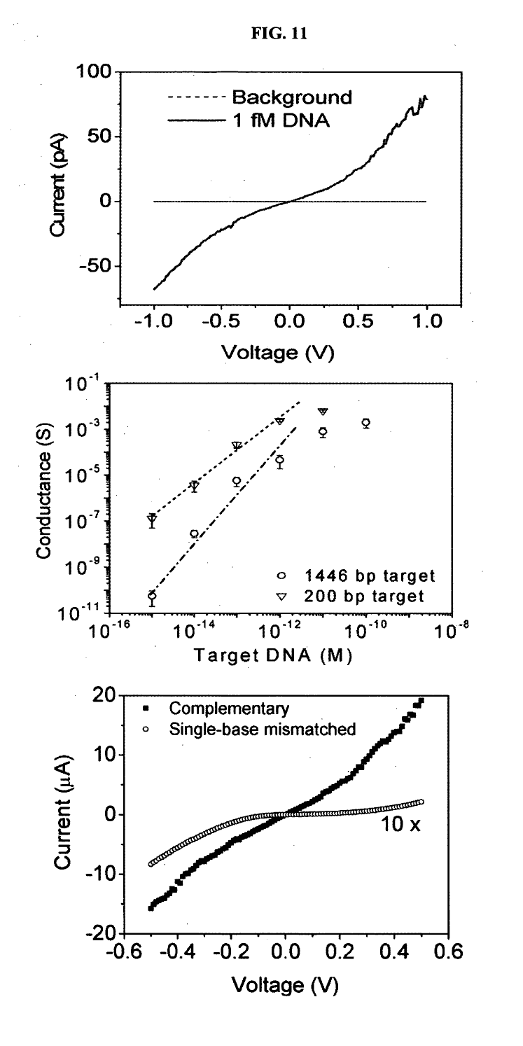

Now, each one set of the capture probes had to be selectively immobilized on one of the two corresponding electrodes across the step formed between the top and bottom electrode (FIG. 10A). In other words, a 10-20 nm resolution of the capture probe immobilization procedure is needed. This step was very critical because it is practically impossible to directly apply the capture probe solution on a particular electrode, even with the help of a robotic spotter. Fortunately, such a task was successfully accomplished by an electrochemical stripping technique. To provide direct evidence, a few representative devices were incubated in TE buffer containing 1.0 μM fluorophore-labeled target DNAs after each step. Referring to the fluorescence image in FIG. 10B, it is apparent that CP1 indeed formed excellent SAMs on the surfaces of both electrodes. To verify the selective removal of CP1, after the electrochemical stripping, the devices were incubated with the Cy3-labeled complementary target and examined under a fluorescence microscope. As shown in FIG. 10C, CP1 was only present on the top electrode of the nano-MIM device (sensor), judging from the complete disappearance of the fluorescence at the bottom electrode. Since a monolayer of CP 1 was already present on the top electrode, the latter treatment with CP2 solution would presumably result in the formation of a SAM of CP2 on the bottom electrode. This was corroborated by incubating a set of the sensors in the TE buffer solution containing 1.0 μM of FAM (green dye)-labeled target DNA with its base sequence complementary to CP2 and the Cy3-labeled DNA with its base sequence complementary to CP1. FIG. 10D provides an excellent visual proof that it was possible to selectively immobilize SAMs of two different capture probes on the surfaces of a pair of nanometer-spaced electrodes. This is the first time that nanometer resolution in DNA immobilization was achieved. In addition, the fluorescence images strongly suggest a high surface coverage of the immobilized capture probes and an excellent hybridization efficiency, which paves the way for the development of ultrasensitive DNA sensing devices. Moreover, nonspecific adsorption on the substrate or the electrode surface was negligible as is evident from the very clean fluorescence images.

Detection of Target DNA

Two terminal electrical measurements were made across the step formed between the two electrodes in each sensor. FIG. 11A depicts a typical current-voltage (i-V) characteristic curve for a sample solution containing 1.0 fM target DNA, as referred to that for the background (control). At a bias voltage of 1.0 V, about 2 orders of magnitude higher current could be detected for the devices after hybridization and silver metallization. The representative curve is nonlinear, which is likely to be caused by intergrain boundary resistance in the silver nanowire. Devices in an array that underwent identical treatments yielded similar i-V curves.

To verify the authenticity of the response, a series of control experiments were conducted. First, CP1 was replaced with another capture probe (CP*; SEQ ID NO: 3) of the same length but having five central bases non-complementary to the corresponding terminal of PKB2. The hybridization, washing, and silver metallization conditions were all kept unchanged. No noticeable change in the background current could be observed, strongly indicating that the non-complementarities introduced into the system precludes the target DNA to completely hybridize with CP* and hence unable to withstand the stringency washes. DNA strands that do not hybridize with the capture probes at the top electrode will probably lie flat at the bottom electrode, having no contribution to the conductance of the device at all.

Furthermore, a droplet of blank buffer solution was spotted, and the device underwent exactly the same procedure. Again, no detectable signal was observed, confirming that output current did not originate from accidental bridging of the nanogap due to uncontrolled enhancement of the silver seeds formed along the capture probes.

Finally, it was verified if the nonspecific adsorption of the long target DNA, for example PKB2, across the step could contribute to the signal. For this test, several freshly cleaned devices, preimmobilized with noncomplementary capture probes, were incubated with the target DNA solution and then followed the optimized silver ion collection and nanowire formation procedures. The absence of any detectable change in conductance further confirmed the reliability of the measured signals.

Utilizing this hybridized DNA-templated formation of silver nanowires as the signal generator, the conductance between the nanogapped electrodes is primarily dependent on the number of the silver nanowires formed between the top and the bottom electrode (bridging). The more the target DNA molecules hybridized, the more the silver nanowires are expected between the two electrodes, thus the higher is the conductance. Under controlled experimental conditions, a simple and straightforward linear relationship between the conductance and the target DNA concentration can be expected. To construct the calibration curve, multiple measurements were carried out for each concentration to obtain the average of the conductance.

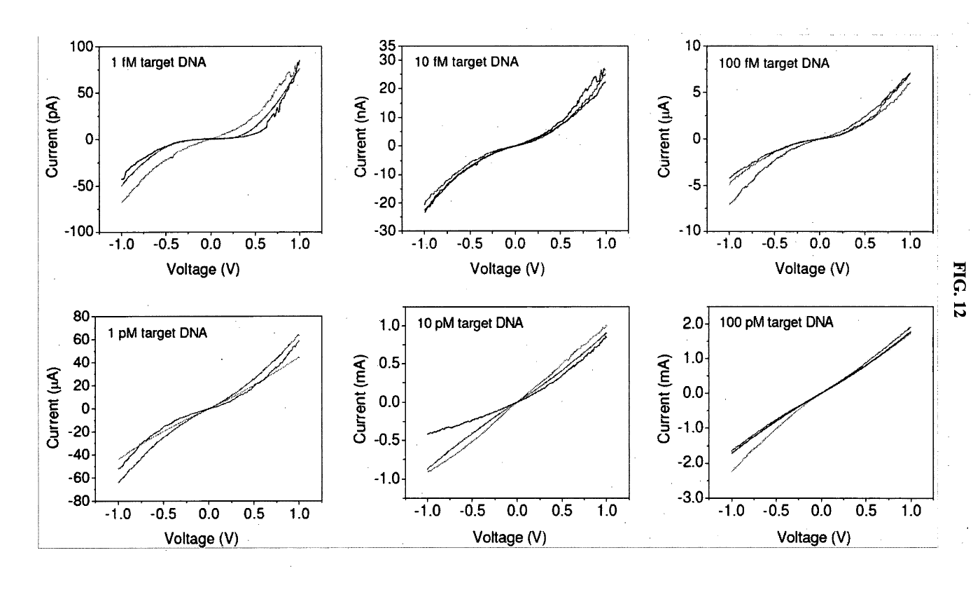

Indeed, as shown in FIG. 11(B) and FIG. 12, conductance between the electrode pair was found to increase with an increase in target DNA concentration. This concentration-dependent conductance was correlated to the statistical number of silver nanowires formed between the electrode pair. In the case of ultralow DNA concentration (e.g., 1.0 fM), only a few copies can potentially hybridize and bridge up the step formed between the electrodes. As the concentration of target DNA in the test solution increases, more DNA strands hybridize across the step, which in turn enhances the number of parallel conduction pathways. Under optimized conditions, the target DNA can be quantitatively detected in a dynamic range from 1.0 fM to 1.0 pM with a total analysis time from hybridization to detection well within 60 min per sensor chip. This sensitivity is comparable to the best of electrochemical/electrical biosensors (Zhang, Y., Austin, R. H., 2002, Phys. Rev. Lett., vol. 89, Art. No. 198102). The regression coefficient R² and the relative standard derivation (RSD) were found to be 0.96 and ≦20%, respectively. Such signal variations reflect the cumulative degree of reproducibility of the capture probe immobilization, hybridization, silver ion collection, and nanowire formation steps. Slightly lower detection limits of 0.3-0.5 fM, depending on the length of the gene (the shorter ones (SEQ ID NO: 5) were more sensitive probably due to higher hybridization efficiency), were achievable after a much prolonged hybridization of 4-6 h but with little practical significance in view of the long hybridization time. As seen in FIG. 11(B), at the high concentration end of the calibration curve, the conductance reached as high as millisiemens, 1.25×10⁹ times higher than the background, which translates into a relative change of 2.1×10⁴% per unit concentration, which is far better than any other electrical transduction-based methods. This huge signal intensity is mainly due to a significantly reduced background conductance (<1.0 pS) achieved with the vertical step (nanogap) since other nano- and microgapped electrodes can also produce a conductance at millisiemens levels but on a huge background of submicrosiemens (Möller, R., Powell, R. D., et al., 2005, Nano Lett., vol. 5, no. 7, pp. 1475).

Unlike planar nano- and microstructures where all target DNA molecules, hybridized, loosely bound, and nonspecifically adsorbed, contribute to the conductance of the device, the extremely low background suggests that the unique vertical nano-MIM structure (sensor structure) and the two-capture probe approach significantly reduce the background to a level comparable to the instrument noise in DNA detection, since bridging is attained only when both termini of the target DNA hybridize with the capture probes. In other words, to generate a conductance increment, the target DNA molecule must be “held” vertically by the two capture probes across the step (nanogap). Target DNA strands found lying at the bottom electrode have very little effect on the conductance. In principle, detections of target DNA strands ≧60 base pairs can be performed with sensors having a step with a height of 10 nm, which cover almost all known genes.

To evaluate the capability of the proposed procedure in discriminating single-base-mismatch (SBM), CP1 was substituted with capture probes of the same length but having only one A-T mismatch in the middle, so that the new devices were single-base-mismatched to the same target DNA. At 1.0 pM, it was found that the conductance increments for the SBM devices were <4% of those found with the fully complementary ones (FIG. 11C). That is to say, the detection of the SBM mutations is possible with the proposed procedure with a SBM selectivity factor of at least 25:1, much higher than that of the optical microarray and most other previously reported methods. Again, this is probably due to the vertical configuration of the step (nanogap), which practically eliminates most of the non-hybridization-related contributions (background). Assuming the background remains unchanged under all circumstances, its contribution to the SBM selectivity can be described as

Background contribution=(S_{comp}+B)/(S_{SBM}+B)−(S_{comp}/S_{SBM}) (1)

where S_{SBM}, B, and S_{comp} are the conductances of SBM DNA, background, and the complementary DNA, respectively. As S_{comp}>S_{SBM} and B<S_{SBM},

Background contribution=B(S_{SBM}−S_{comp})/(S_{SBM}(S_{SBM}+B))<0 (2)

As seen in equation (2), the background contribution to the SBM selectivity is always negative. With a high background, a significant amount of the mismatch selectivity is lost. The true SBM selectivity of hybridization-based DNA sensors can only be realized when the background is negligible.

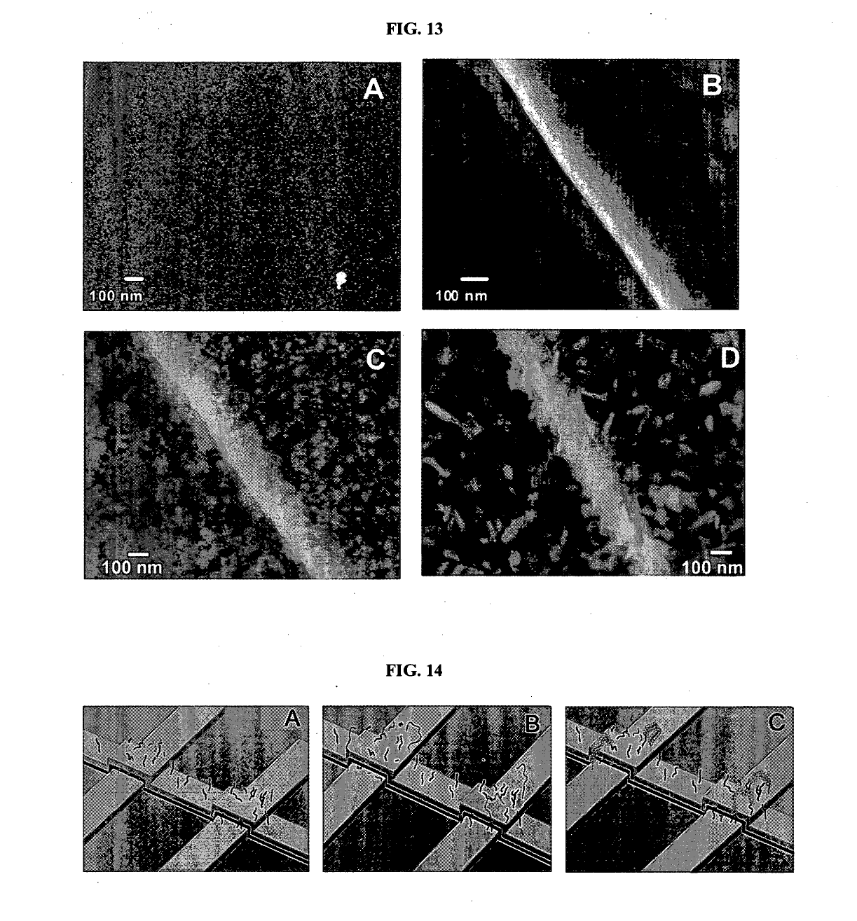

SEM characterization was then performed on the biosensor chips exposed to the control (FIG. 13(C) and to the complementary DNA samples (FIG. 13(D). The images are shown in FIG. 13. It is seen that the silicon oxide surface of the sensor chip showed no visible change before and after silver deposition (FIG. 13(A)), while after silver nanowire deposition, the capture probe coated gold electrodes were obviously roughened by the presence of the silver nanowire, or rather nanoparticles, which were supposed to be the agglomeration of the short nanowires (FIG. 13(C)). For comparison, the SEM image of a blank sensor chip is represented as FIG. 13(B).

One possible reason may be the densely packed short capture probes (6-7 nm) which will inevitably aggregate with the growth of the silver nanowires. Another possible reason may be that the overwound polymorph and agglomeration of the silver nanowires occurred with the concomitant shielding of the negative charges on the capture probes with the proceeding of the silver nanowire formation, reducing the electrostatic repulsion between adjacent capture probes. The capture probes are supposed to “stand” on the gold surface due to electrostatic repulsion between adjacent strands. The shielding of the negative charges with the proceeding of silver formation leads to the aggregation of the DNA-silver adducts. The capture probes no longer stand on but bend down to the gold surface. Therefore, the deposited silver was likely to take on an uneven agglomerated netlike configuration other than independent wires with clear boundaries.

Fortunately, agglomeration is a desirable feature in developing an electrical detection procedure with the vertically aligned step (nanogap) electrodes because it facilities the formation of two-dimensional features on the electrode surface instead of three-dimensional features toward the top electrode, largely reducing the possibility of step bridging by the capture probes and making it possible to read electrical signal with high signal-to-noise ratio.

The morphology of the silver deposited at the control is distinctly different from the wire like silver deposited at the complementary DNA hybridized sensor surface under identical conditions (FIG. 13D). A close examination of FIG. 13D revealed that, indeed, there are some silver nanowires vertically aligned across the step, effectively bridging the two gold electrodes, generating a measurable electrical signal.

The sensor referred to herein provides a novel ultrasensitive sensor array for the detection of DNA with a femtomolar detection limit after 30 min hybridization. This sensitivity is among the best of electrical nucleic acid biosensors. Also disclosed is a fabrication technique of the nano-MIM sensor or sensor array that can be mass produced using conventional, high-yield fabrication processes. Because of the extremely low background, exceptional signal intensity and excellent mismatch discrimination were obtained. Following the present process steps, the sensor array can be integrated on a readout unit for detecting a range of target DNAs. The sensor arrays detailed in this work can be especially beneficial where rapid, parallel DNA analysis is needed (e.g., for characterizing pathogens, measuring mRNA levels during expression profiling, or point-of-care applications).

Capture Probe Immobilization for RNA Detection

The above experiments referred to the detection of DNA. In the following an embodiment using a sensor of the present invention for the detection of RNA is presented. The nucleic acids used in this RNA detection method are disclosed in Table 1.

TABLE 1
Nucleic acid sequences used in the RNA detection method

| | | |
|---|---|---|
| GAPDH | 3′-HS-(CH₂)₆-TGTACCGGAGGTTCCCTCATT-5′ | SEQ ID NO: 6 |
| BRCA1 | 3′-HS-(CH₂)₆-GGACTATGAAAAGACCTACGGAG-5′ | SEQ ID NO: 7 |
| His4 | 3′-HS-(CH₂)₆-TCCATTGACGTAGCGCCTAA-5′ | SEQ ID NO: 8 |
| Annealing | 3′-TTTTTTTTTTTTTTTTTT-(CH₂)₆-SH-5′ | SEQ ID NO: 9 |
| probe | | |

The proposed approach of utilizing the stepped electrode arrangement to detect mRNA involves a pair of oligonucleotide capture probes, namely capture probes (CP) (SEQ ID NO: 6, 7 and 8) and annealing probes (AP) (SEQ ID NO: 9), for each target mRNA. The characteristics of CPs are unique to the representative mRNAs to be detected and have similar melting temperatures. And APs (Poly (T)) are complementary to the poly (A) tails of all mRNAs and have exactly the same length (SEQ ID NO: 9). To have the highest capture efficiency and the lowest uptake of non-hybridization related mRNA uptake, the two sets of probes are designed in a way that there is little hybridization of the mRNA poly (A) tails when target mRNAs are being selectively hybridized to the capture probes. In brief, 2.0-μl droplets of 1.0 μM CP solutions were applied to the 5×5 array clusters of a freshly-cleaned sensor array chip. After 2 h of incubation at room temperature, it was rinsed with copious amount of water and dried in a stream of nitrogen. At this stage, one could expect self-assembled monolayers (SAM) of CP on both electrodes (top and bottom) through thiol-gold interaction. Subsequently, the device was subjected to electrochemical stripping that would selectively and completely remove CP from the top electrode. A single potential cycling of the top electrode was performed between 0 and 1.0 V (vs. Ag/AgCl) at a scan rate of 200 mV/s. Next, the whole sensor chip was incubated in 1.0 μM AP in PBS for 2 h at room temperature. It was ready after a thorough wash with water.

Hybridization and Detection of mRNA

After immobilization of CP and AP on the two electrodes respectively, the step was bridged by 30-min hybridization with aliquots of 2.0 μl of total RNA in TE buffer where the two termini were complementary to the two surface-bound CP and AP, respectively. After the first hybridization, the device underwent three stringency washes with SSC buffer (80 mM NaCl+8 mM sodium citrate+0.1% sodium dodecyl sulfate; 5-7° C. below melting temperature) to remove any nonspecifically adsorbed or partially hybridized mRNA strands. Thereafter, aliquots of TEM buffer were added onto the chip at room temperature. At this stage, the poly(A) tails of the hybridized mRNA at the bottom electrode further hybridizes with AP on the top electrode, forming mRNA “bridges” across the nanogap.

Finally, the hybridized mRNA strands across the step were made electrically conducting by a simple mRNA-templated formation of silver nanowire alongside the mRNA bridges as already described above.

Results

Sensor Array Fabrication

Illustrations of the sensor along with the sensing procedure used for the detection of RNA are depicted in FIG. 14. The SiO₂ insulating layer forms a “step” between the top surface of the top electrode and the top surface of the bottom gold electrodes on which two capture probes with different sequences, complementary to the 5′-end and 3′-end of the mRNA respectively, were immobilized. Bridging of this step by the target mRNA strand, upon hybridization and subsequent silver nanowire formation, creates a primary current pathway (FIG. 14, A-C). Firstly, vital to the feasibility of this approach is to have an excellent insulating SiO₂ or, in other words, a nominal leakage current (or the conductance) of the blank sensor chip, which should at least be an order of magnitude lower than the lowest signal generated after mRNA bridging. As described already above, the leakage current is in general primarily due to tunneling of charge carriers through the SiO₂ insulating layer in the relatively large common area of the electrodes (10 μm×10 μm). Thus, a sensor with a very smooth, compact and homogenous insulating layer was fabricated and used herein (see above). Using the process described herein it was possible to fabricate sensor arrays of different gap sizes that vary from 5 nm to 100 nm with precise control of gap size (<±1.0 nm) with high device uniformity and unlimited scalability. In principle, detections of target mRNA strands ≧50 or ≧60 base can be performed at 10 nm sensor arrays, which covers all known genes in eukaryotic organisms.

Secondly, the CP and AP pair have to be selectively immobilized on the two corresponding electrodes across the nanogap, respectively, implying that a 5-10 nm resolution of the capture probe immobilization procedure is needed. As described above, this step is important because it is practically impossible to adopt any of the existing capture probe immobilization techniques for this purpose. Therefore the stripping technique already described above was used to immobilize different probes on the two electrodes.

To provide direct evidence, a representative 5×5 cluster was chosen and incubated it in TE buffer containing 1.0 μM of FAM (green dye)-labeled target oligonucleotide, with its base sequence complementary to AP, and the Cy3 (red dye)-labeled oligonucleotide with its base sequence complementary to CP. FIG. 10 A-D provides an excellent visual proof that it was possible to selectively immobilize the two different capture probes on the surfaces of a pair of nanometer-spaced electrodes. This is the first time that nanometer resolution in nucleic acid immobilization was achieved.

In addition, the fluorescence images strongly suggest a high surface coverage of the immobilized capture probes and an excellent hybridization efficiency, which paves the way for the development of ultrasensitive mRNA sensing devices. Moreover, non-specific adsorption on the substrate or the electrode surface was negligible as is evident from the very clean and perfectly confined fluorescence images.

FIG. 14 A-C show step-by-step of the working principle of the biosensor array. Two monolayers of CP and AP were assembled on the bottom and top gold electrode across the nanogap, respectively, acting as the bioaffinitive sensing interface (FIG. 14(C)). The interaction of CP with sample mRNA forms a duplex, bringing the target mRNA onto the bottom electrode (FIG. 14(D)). The poly(A) tail of the hybridized mRNA serves an anchoring site, providing the requisite local environment to facilitate bridging across the step. As a result, the hybridized mRNA strand in the close proximity of the step is held vertically across the step after hybridizing with AP on the top electrode and formation of the hybridized mRNA-templated silver nanowires across provides much needed sensitivity for the detection of mRNA (FIG. 14(E)).

To minimize non-hybridization-related uptake of mRNA and to increase the hybridization efficiency, the CP and AP are designed in this embodiment in a way that there is at least 20° C. difference in melting temperature so that there is very little hybridization of the poly(A) tail during the target mRNA capture process (first hybridization). And the high density of anionic AP on the top electrode alleviates the non-specific adsorption of the mRNA, producing a high signal/noise ratio.

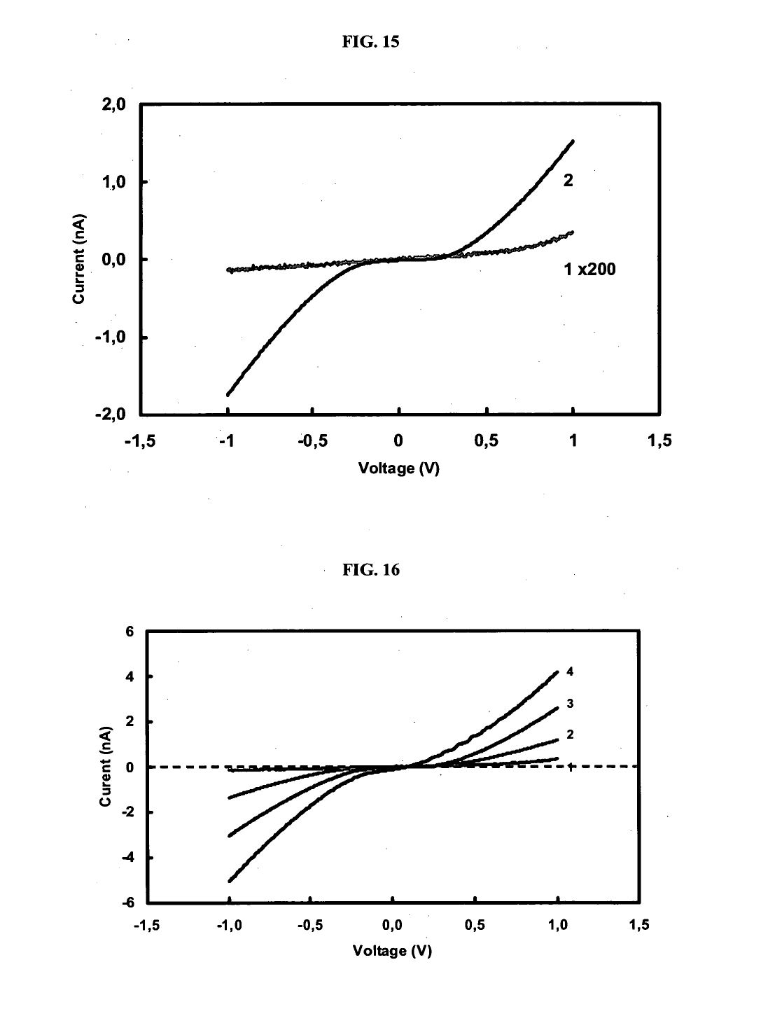

In the first feasibility test, 100 ng of total RNA was tested at a biosensor array where the CP and AP pair were designed for GAPDH mRNA. Upon hybridizing at 50° C. for 30 min and annealing at 25° C., respectively, GAPDH was selectively bound to its complementary CP and AP and became fixed on the biosensor surface across the step. Silver nanowires were produced alongside the hybridized GAPDH strands via mRNA-templated silver metallization formation during a subsequent incubation. Typical i-V curves of the biosensor after silver treatment are shown in FIG. 15. For comparison, FIG. 15 trace 1 is the i-V curve of a biosensor in which the bottom electrode was coated with non-complementary CP (control biosensor) after the same treatments. As seen in FIG. 15, a considerably higher current (conductance, at 1.0 V) was observed at the hybridized sensor than that of the control. Extensive washing and voltage ramping between −1.0 and 1.0 V produced no noticeable changes, revealing that the silver nanowires are robustly bound to the hybridized mRNA stands between the two gold electrodes, effectively bridging over the step.

It is expected that the hybridizations of the target mRNA to CP and AP resulted in the formation of vertically aligned mRNA strands across the step. When the hybridized biosensor array is incubated in the silver metallization solution, silver ions are concentrated and aligned around the hybridized mRNA strands through electrostatic interaction and chemical bonding. This high silver concentration around the mRNA provides a local environment of high density of silver nucleation centers after reduction that facilitates a predominantly formation of silver nanowires alongside the mRNA strands, offering the much desired structure for high conductance. The thus formed silver nanowires in which silver wraps around the mRNA template is utilized for mRNA sensing. A sizeable increase in conductance was obtained for the complementary mRNA, whereas only a slight increase was observed for the control sensor when compared to the leakage current of the blank sensor.

This clearly demonstrates that the formation of the silver nanowires across the step is guided by the hybridized mRNA strands and the resulted silver nanowire network effectively bridges the step (nanogap), producing a measurable conductance change. The result of the control implies that the non-hybridization-related signal of this biosensor array is extremely low, which facilitates the detection of mRNA at ultralow concentrations. This may be attributed to the two-step capturing and annealing hybridization and the use of the vertically aligned step in a sandwich-type configuration other than conventional planar arrangement. In addition, the i-V curves were non-linear at low mRNA concentrations, which is likely to be caused by inter-grain boundary resistance in the silver nanowire.

To further confirm that the conductance increase is indeed due to the hybridized GAPDH, successive aliquots of GAPDH cDNA were spiked into the total RNA in 5.0 fM increments before hybridization and monitoring the change in conductance. Further increases in conductance were observed (FIG. 16). The signals observed for the spiked-in total RNA increased linearly with the increase in GAPDH cDNA concentration, suggesting that the signal generated in the total RNA sample is originated form GAPDH mRNA and giving a preliminary indication of the reproducibility of sensor array.

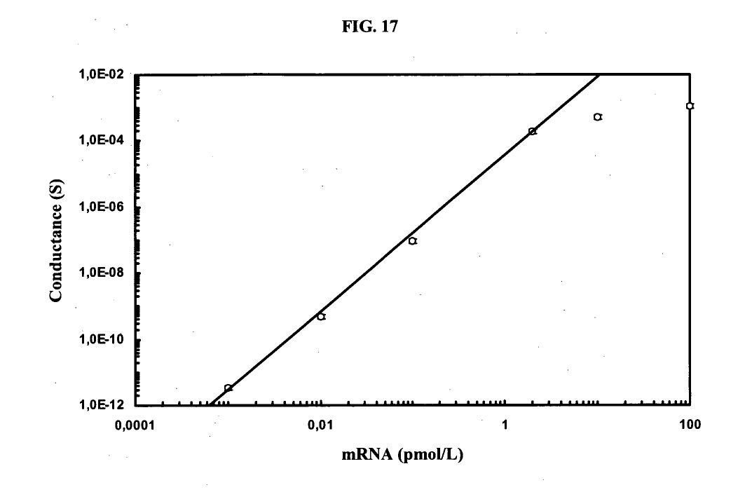

The applicability of the proposed biosensor array in mRNA expression analysis was then tested on genomic samples. In this study, full length GAPDH (1008 bp) was used as calibration standards. Solutions of different concentrations of mRNAs, ranging from 0.10 fM to 100 pM, were tested. For the control experiments, non-complementary capture probes were used in the sensor preparation. As illustrated in FIG. 17, the dynamic range for GAPDH 0.5 fM-10 pM with a relative standard deviations of <10% and a detection limit of 0.30 fM. Compared to previous direct mRNA detection procedures, in the proposed procedure, the hybridized mRNA strands are forced to line up across the step gap, which greatly enhances the bridging power and the response of the electrical detection, and hence the sensitivity and detection limit of the biosensor array. The sensitivity now is determined by the density and diameter of the silver nanowires which in turn determined by the total number of aligned mRNA strands across the step gap. Hypothetically, if silver metallization and hybridization efficiency remain unchanged for all mRNAs, the same signal intensity (conductance per unit concentration) and detection limit should be obtained. However, it was found that both the sensitivity and detection limit are dependent on the length of the target mRNA, the longer the mRNA, the higher signal intensity and the detection limit with no straightforward relationship between the length and the signal intensity (or detection limit) was observed, suggesting that the metallization and hybridization efficiency are also dependent on the length of the target mRNA.

It is understandable that lower hybridization efficiency is expected with longer target mRNA and hence the higher detection limit. The higher signal intensity could be a direct result of the formation of broader silver nanowires alongside the longer mRNA due to the existence of secondary structure in the unhybridized regions. As seen in FIG. 17, at the high concentration end of the calibration curve, the conductance reached as high as millisiemens, ˜10⁹ times higher than the background, which translates into a relative change of ˜2×10⁴% per unit concentration, which is far better than any other electrical transduction-based biosensors. This huge signal intensity is mainly due to a significantly reduced background conductance (<1.0 pS) achieved with the vertical step between the electrode surfaces since other nano- and micro-step electrodes can also produce a conductance at millisiemens levels, but on a huge background of sub-microsiemens.

Unlike planar nano- and microstructures where all target nucleic acid molecules, hybridized, loosely bound, and non-specifically adsorbed, contribute to the conductance of the device. The extremely low background suggests that the unique vertical arrangement and the two-step hybridization approach significantly reduces the background to a level comparable to the instrument noise in nucleic acid detection since bridging is attained only when both 5′- and 3′-end of the target mRNA hybridize with the CP and AP, respectively. In other words, to generate a conductance increment the target mRNA strand must be “held” vertically by the CP and AP across the step formed between the top surfaces of the electrodes. Messenger RNA strands found lying at the bottom electrode have very little effect on the conductance.

With the much improved sensitivity, the sensor array allowed it to analyze mRNA expression in real world samples, total RNA extracted from HeLa cells. Expression levels of the three representative mRNAs were determined by the proposed biosensor and by RT-qPCR. The results were normalized to total RNA. The results obtained with the biosensor are in good agreement with those of RT-qPCR analysis on the same sample. The relative errors associated with mRNA assays on individual miRNAs were generally less than 10%, in the concentration range of 5.0 fM to 2.0 pM. Therefore, it allows to identify mRNAs with less than 50% difference (>3×10%) in expression levels under two conditions. This is advantageous because the expressions of many of the most interesting mRNAs often differ lightly under different conditions. The proposed sensor array offers a greater accuracy in the identification of differentially expressed mRNAs and cuts down on the need for running too many replicates. As compare to the conventional mRNA expression techniques, with the greatly improved sensitivity the proposed method also significantly reduce the amount of total RNA needed from micrograms to nanograms.

The PCR-free sensor array described above is simple, sensitive, and largely immune to sample-dependent biases. It can measure mRNA directly in complex samples with high sensitivity and specificity because it minimizes sample manipulation, integrates direct hybridization of mRNA to signal generation. An assay that directly utilizes total RNA minimizes the inevitable sample losses in more complex protocols requiring RNA size fractionation or multiple purification steps. There is thus a need for a quantitative assay capable of measuring expression of all mRNAs simultaneously. A quantitative assay requires that each step proceed in reproducibly high yield and be insensitive to small deviations from the standard protocol. These goals are facilitated if there are no amplifications or minimal separation steps that can introduce sample-dependent variations and if both labeling and hybridization reach stable endpoints near equilibrium, minimally dependent on reaction kinetics or concentrations. The proposed array allows hybridizations to proceed simultaneously and far toward equilibrium under practically identical conditions. And the similar melting temperatures of CPs ensure that most mRNAs will be predominately hybridized at equilibrium. The exceptional signal intensities allow accurate measurements of the number of hybridized mRNA strands. Thus, the array presented here can serve as the foundation for the future development of a truly quantitative, fully multiplexed mRNA expression assay.

1. A sensor for detecting a nucleic acid molecule comprising:
an electrode arrangement comprising a first electrode, a second electrode and an overlapping region, wherein, within the overlapping region:
a part of the second electrode overlaps a part of the first electrode such that a top surface level of the second electrode is higher than a top surface level of the first electrode;
an insulating layer is provided between the first electrode and the second electrode and is contacting the first electrode and second electrode;
a first nucleic acid probe immobilized at the surface of the first electrode; and
a second nucleic acid probe immobilized at the surface of the second electrode.

2. The sensor of claim 1, wherein within the overlapping region the side surface of the second electrode and the insulating layer is aligned with respect to the top surface of the second electrode by an angle of about 90°±30°.

3. The sensor of claim 1, wherein the first and the second electrode are made of a material which is selected from the group consisting of a noble metal, doped silicon, doped poly silicon, silicon germanium, titanium (Ti), tantalum (Ta), tungsten (W), aluminum (Al), chromium (Cr), copper (Cu), a metal alloy and a conducting polymer.

4-5. (canceled)

6. The sensor of claim 3, wherein the first and the second electrode are made of the same material or different materials.

7. The sensor of claim 1, wherein the electrode arrangement is arranged on a substrate.

8-11. (canceled)

12. The sensor of claim 7, wherein the substrate is further arranged on a semiconducting layer.

13-19. (canceled)

20. The sensor of claim 1, wherein an adhesion layer is arranged between the insulating layer and the first electrode and/or between the insulating layer and the second electrode.

21-23. (canceled)

24. The sensor of claim 1, wherein the first nucleic acid probe and the second nucleic acid probe have a length of at least 10 nucleotides, or at least 40 nucleotides, or at least 60 nucleotides.

25. The sensor of claim 1, wherein the first nucleic acid probe and the second nucleic acid probe comprise the same or different nucleotide sequence.

26. (canceled)

27. The sensor of claim 1, wherein the nucleic acid is DNA, RNA or derivatives thereof.

28. The sensor of claim 1, wherein the first nucleic acid probe and/or the second nucleic acid probe are immobilized at the surface of the respective electrode via a chemical linker.

29. The sensor of claim 1, wherein multiple sensors are arranged in a sensor array.

30. A nucleic acid detection kit comprising:
a sensor for detecting a nucleic acid molecule comprising:
an electrode arrangement comprising a first electrode, a second electrode and an overlapping region, wherein, within the overlapping region:
a part of the second electrode overlaps a part of the first electrode such that a top surface level of the second electrode is higher than a top surface level of the first electrode;
an insulating layer is provided between the first electrode and the second electrode and is contacting the first electrode and second electrode;
a first nucleic acid probe immobilized at the surface of the first electrode; and
a second nucleic acid probe immobilized at the surface of the second electrode;
a solution comprising a metal precursor; and
a solution suitable for chemically reducing the metal precursor.

31. A process of manufacturing a sensor for detecting a nucleic acid molecule comprising:
an electrode arrangement comprising a first electrode, a second electrode and an overlapping region, wherein, within the overlapping region:
a part of the second electrode overlaps a part of the first electrode such that a top surface level of the second electrode is higher than a top surface level of the first electrode;
an insulating layer is provided between the first electrode and the second electrode and is contacting the first electrode and second electrode;
a first nucleic acid probe immobilized at the surface of the first electrode; and
a second nucleic acid probe immobilized at the surface of the second electrode,
wherein the process comprises:
providing an electrode arrangement as referred to claim 1 comprising a first electrode and a second electrode; and
immobilizing a first nucleic acid probe at the surface of the first electrode and the second electrode.

32. The process of claim 31, wherein in case the nucleic acid probe immobilized at either the first electrode or second electrode is to be different from the nucleic acid probe immobilized at the respective other electrode, the process further comprises after the step of immobilizing a first nucleic acid probe, the following steps:
stripping of the first nucleic acid probe from the surface of the first electrode or the second electrode by potential cycling of either the first electrode or the second electrode; and
immobilizing a second nucleic acid probe at the surface of the electrode from which the first nucleic acid has not been stripped of.

33. The process of claim 32, wherein the stepped electrode arrangement is manufactured by:
forming a first electrode on a substrate;
forming an insulating layer covering the substrate and the first electrode;
forming a second electrode covering a portion of the substrate covered with the insulating layer;
wherein the second electrode is formed to overlap a portion of the first electrode covered with the insulating layer;
removing the portion of the insulating layer which is not covered by the second electrode.

34-40. (canceled)

41. The process of claim 32, wherein the potential cycling is carried out at between about 0.1 to about 1 V.

42. The process of claim 32, wherein the scan rate for potential cycling is about 150 to 250 mV/s or about 200 mV/s.

43. A method of detecting a target nucleic acid comprising:
providing a sensor for detecting a nucleic acid molecule comprising:
an electrode arrangement comprising a first electrode, a second electrode and an overlapping region, wherein, within the overlapping region:
a part of the second electrode overlaps a part of the first electrode such that a top surface level of the second electrode is higher than a top surface level of the first electrode;
an insulating layer is provided between the first electrode and the second electrode and is contacting the first electrode and second electrode;
a first nucleic acid probe immobilized at the surface of the first electrode; and
a second nucleic acid probe immobilized at the surface of the second electrode,
wherein the sensor comprises two electrodes and wherein nucleic acid sequences are immobilized at the surface of the electrodes which are complementary to the target nucleic acid sequence;
incubating the sensor with a sample fluid suspected to comprise the target nucleic acid;
metallizing the nucleic acid molecules of the sensor; and
carrying out conductance measurements to determine the presence or absence of the target nucleic acid.

44. The method of claim 43, wherein metallizing comprises:
incubating the sensor with a solution comprising a metal precursor;
incubating the sensor with a solution suitable for chemically reducing the metal precursor.


SEQUENCE LISTING (9 sequences)

SEQ ID NO: 1 - DNA, 30 bp, Artificial
  Capture probe (CP1) on top electrode; 3ThioMC3-D at 3′-end
gatgacagacacctcattcataaaaaaaaa

SEQ ID NO: 2 - DNA, 30 bp, Artificial
  Bottom capture probe (CP2) on bottom electrode; 5ThioMC6-D at 5′-end
aaaaaaaaatcactcgcggatgctggccga

SEQ ID NO: 3 - DNA, 30 bp, Artificial
  5-mismatched top capture probe (CP*); 3ThioMC3-D at 3′-end
gatgacagtgtggtcattcataaaaaaaaa

SEQ ID NO: 4 - DNA, 1446 bp, Homo sapiens
atgaatgaggtgtctgtcatcaaagaaggctggctccacaagcgtggtgaatacatcaagacctggaggccacggtacttcctgctgaagagcgacggctccttcattgggtacaaggagaggcccgaggcccctgatcagactctaccccccttaaacaacttctccgtagcagaatgccagctgatgaagaccgagaggccgcgacccaacacctttgtcatacgctgcctgcagtggaccacagtcatcgagaggaccttccacgtggattctccagacgagagggaggagtggatgcgggccatccagatggtcgccaacagcctcaagcagcgggccccaggcgaggaccccatggactacaagtgtggctcccccagtgactcctccacgactgaggagatggaagtggcggtcagcaaggcacgggctaaagtgaccatgaatgacttcgactatctcaaactccttggcaagggaacctttggcaaagtcatcctggtgcgggagaaggccactggccgctactacgccatgaagatcctgcgaaaggaagtcatcattgccaaggatgaagtcgctcacacagtcaccgagagccgggtcctccagaacaccaggcacccgttcctcactgcgctgaagtatgccttccagacccacgaccgcctgtgctttgtgatggagtatgccaacgggggtgagctgttcttccacctgtcccgggagcgtgtcttcacagaggagcgggcccggttttatggtgcagagattgtctcggctcttgagtacttgcactcgcgggacgtggtataccgcgacatcaagctggaaaacctcatgctggacaaagatggccacatcaagatcactgactttggcctctgcaaagagggcatcagtgacggggccaccatgaaaaccttctgtgggaccccggagtacctggcgcctgaggtgctggaggacaatgactatggccgggccgtggactggtgggggctgggtgtggtcatgtacgagatgatgtgcggccgcctgcccttctacaaccaggaccacgagcgcctcttcgagctcatcctcatggaagagatccgcttcccgcgcacgctcagccccgaggccaagtccctgcttgctgggctgcttaagaaggaccccaagcagaggcttggtggggggcccagcgatgccaaggaggtcatggagcacaggttcttcctcagcatcaactggcaggacgtggtccagaagaagctcctgccacccttcaaacctcaggtcacgtccgaggtcgacacaaggtacttcgatgatgaatttaccgcccagtccatcacaatcacaccccctgaccgctatgacagcctgggcttactggagctggaccagcggacccacttcccccagttctcctactcggccagcatccgcgagtga

SEQ ID NO: 5 - DNA, 200 bp, Homo sapiens
atgaatgaggtgtctgtcatcaaagaaggctggctccacaagcgtggtgaatacatcaagacctggaggccacggtacttcctgctgaagagcgacggctccgggctccggggactagtctgagatggggggaatttgttgaagaggcatcgtcttacggtcgactacttctggctctctcggccagcatccgcgagtga

SEQ ID NO: 6 - DNA, 21 bp, Artificial
  GAPDH Capture probe
tgtaccggaggttccctcatt

SEQ ID NO: 7 - DNA, 23 bp, Artificial
  BRCA1 Capture probe
ggactatgaaaagacctacggag

SEQ ID NO: 8 - DNA, 20 bp, Artificial
  His4 Capture Probe
tccattgacgtagcgcctaa

SEQ ID NO: 9 - DNA, 18 bp, Artificial
  Annealing Probe (RNA Detection)
tttttttttttttttttt